(19) United States
(12) Patent Application Publication
(10) Pub. No.: US 2020/0010354 A1
(43) Pub. Date: Jan. 9, 2020

(54) HIGHLY STABLE AND CHEMICALLY TEMPERABLE GLASSES

(71) Applicant: Schott AG, Mainz (DE)

(72) Inventors: Ulrich Fotheringham, Wiesbaden (DE); Peter Nass, Mainz (DE); Michael Schwall, Knoxville, TN (US); Christian Mix, Landshut (DE); Ulf Dahlmann, Landshut (DE)

(73) Assignee: Schott AG, Mainz (DE)

(21) Appl. No.: 16/460,061

(22) Filed: Jul. 2, 2019

(30) Foreign Application Priority Data
Jul. 6, 2018 (DE) 10 2018 116 460.2

(51) Int. Cl. C03C 3/087; C03C 3/062; C03C 4/20; C03C 4/18

(52) U.S. Cl. CPC C03C 3/087; C03C 3/062; C03C 2204/00; C03C 4/18; C03C 4/20

(57) ABSTRACT

Glasses and glass products which combine the chemical temperability with very good alkali and acid resistance, hydrolytic resistance, as well as a desired coefficient of thermal expansion are provided. The glass has a composition characterized by the following constituent phases: a composition characterized by the following constituent phases: 20-60 mol % albite; 0-40 mol % silicon dioxide; 0-20 mol % orthoclase; 0-10 mol % wollastonite; 0-20 mol % enstatite; 0-20 mol % parakeldyshite; 0-20 mol % narsarsukite; 0-40 mol % disodium zinc silicate; 0-20 mol % cordierite; 0-10 mol % strontium silicate; and 0-10 mol % barium silicate.

### BACKGROUND OF THE INVENTION

### 1. Field of the Invention

The invention relates to glasses and glass products which combine chemical temperability with very good alkali and acid resistance, hydrolytic resistance as well as a desired coefficient of thermal expansion. The invention also includes methods for the production of such glasses and their uses.

### 2. Description of the Related Art

Chemically temperable glasses are required for many uses, in particular for uses in the fields of pharmaceutical packaging or touch-sensitive displays (touch panel). Here, generally, a certain coefficient of thermal expansion is still required and, despite, inter alia, the sodium ions which are present in large number by reason of temperability, the alkali, the hydrolytic and the acid resistances may not be compromised. For the characterization of the chemical stability there is an abundance of regulations and standards, in particularly ISO 695 for the alkali resistance, ISO 719/720 for the hydrolytic as well as ISO 1776 and DIN 12116 for the acid resistance.

DE 10 2015 116 097 A1, U.S. Pat. No. 9,783,453 B2, US 2015/030827 A1, U.S. Pat. No. 9,701,580 B2, U.S. Pat. No. 9,156,725 B2, U.S. Pat. No. 9,517,967 B2, US 2014/050911 A1, U.S. Pat. No. 9,822,032 B2, US 2015/147575 A1, US 2015/140299 A1, WO 15/031427 A2, US 2017/320769 A1, WO 17/151771 A1, US 2016/251255 A1, DE 10 2013 114 225 A1 teach glasses which are intended for the use in the field of touch panels. But with respect to the chemical temperability for the glasses described therein, mainly a high proportion of glass-like albite (12.5 mol % of Na₂O, 12.5 mol % of Al₂O₃, 75 mol % of SiO₂) as constituent phase is emphasized, wherein little scope is left for other phases which may have a positive influence on the chemical temperability.

The selection of glass-like albite as main constituent was due to the high mobility of sodium ions in this glass system with which in the case of chemical prestressing (or chemical tempering) by the exchange of sodium with potassium a high exchange depth (depth of layer) (typically 30-50 μm) can be achieved. Also, the mineral albite is characterized by a high mobility of sodium ions. The extent compressive stress in the layer near to the surface does not depend on this mobility, but on the concentration of sodium in the starting glass.

Since the high mobility of the sodium ions in the albite glass is connected with the high proportion of aluminum and a high proportion of aluminum dramatically decreases the acid resistance, it is reasonable to use besides albite glass also other sodium sources which promise a high sodium mobility, e.g. disodium zinc silicate.

What is needed in the art are glasses which combine chemical temperability with a good chemical stability. In addition, these glasses should have desired properties of thermal expansion. Furthermore, it should be possible to produce the glasses in modern tube drawing processes or flat glass drawing processes.

### SUMMARY OF THE INVENTION

Exemplary embodiments provided according to the present invention provide a targeted combination of stoichiometric glasses, thus glasses which in the same stoichiometry also exist as crystals, and the property of which can be assumed to be very similar due to the identical topology of the assemblies each for glass and crystal, which was verified in literature in many examples by NMR measurements or the like. In this application these stoichiometric glasses are also referred to as “constituent phases.”

### DETAILED DESCRIPTION OF THE INVENTION

It is not a new concept to describe glasses on the basis of the constituent phases to be assigned to them. With the information about the base glasses it is possible to draw conclusions with respect to the chemical structure of a glass (cf. Conradt R.: “Chemical structure, medium range order, and crystalline reference state of multicomponent oxide liquids and glasses”, in Journal of Non-Crystalline Solids, Volumes 345-346, 15 Oct. 2004, pages 16-23).

Exemplary embodiments provided according to the present invention provide a glass having a composition which is characterized by the following phases constituent in the glass, wherein, according to the present invention, this base system being defined by the constituent phases is limited by the composition ranges as follows:

TABLE 1

| Constituent phase | Min (mol %) | Max (mol %) |
|---|---|---|
| albite | 20 | 60 |
| silicon dioxide | 0 | 40 |
| orthoclase | 0 | 20 |
| wollastonite | 0 | 10 |
| enstatite | 0 | 20 |
| parakeldyshite | 0 | 20 |
| narsarsukite | 0 | 20 |
| disodium zinc silicate | 0 | 40 |
| cordierite | 0 | 20 |
| strontium silicate | 0 | 10 |
| barium silicate | 0 | 10 |

The base systems explicitly relate to the constituent phases mentioned in each and not to the ordinary oxides. However, the glasses may contain at most 12.5 mol % of Al₂O₃ for allowing an advantageous solution within the scope of these constituent phases. Thus, glasses with a content of aluminum oxide of higher than 12.5 mol %, after conversion into the oxide composition, may not be part of some embodiments.

Furthermore, the glass provided according to the present invention should fulfil further requirements which are associated (with respect to the formula) with the composition out of constituent phases and/or the composition out of ordinary oxides, as further explained below.

Since both kinds of relationships—such ones with respect to a composition which is given in constituent phases and such ones with respect to a composition which is given in ordinary oxides—are used side by side, here at first are provided conversion matrices for the mutual conversion of both composition data.

For the purpose of conversion the composition out of constituent phases is given in a standardized form which is as follows:

TABLE 2

| | Formula (normalized to |
|---|---|
| Constituent phase | an ordinary oxide) |
| albite | (Na₂O•Al₂O₃•6SiO₂)/8 |
| silicon dioxide | SiO₂ |
| orthoclase | (K₂O•Al₂O₃•6SiO₂)/8 |
| wollastonite | (CaO•SiO₂)/2 |
| enstatite | (MgO•SiO₂)/2 |
| parakeldyshite | (Na₂O•ZrO₂•2SiO₂)/4 |
| narsarsukite | (Na₂O•TiO₂•4SiO₂)/6 |
| disodium zinc silicate | (Na₂O•ZnO•3SiO₂)/5 |
| cordierite | (2MgO•2Al₂O₃•5SiO₂)/9 |
| strontium silicate | (SrO•SiO₂)/2 |
| barium silicate | (BaO•SiO₂)/2 |

The conversion of these compositions into composition data in mol % with respect to the following ordinary oxides listed in Table 3 is conducted with the help of the matrix provided in Table 4.

TABLE 3

| # | Oxide |
|---|---|
| 1. | SiO₂ |
| 2. | TiO₂ |
| 3. | ZrO₂ |
| 4. | Al₂O₃ |
| 5. | ZnO |
| 6. | MgO |
| 7. | CaO |
| 8. | SrO |
| 9. | BaO |
| 10. | Na₂O |
| 11. | K₂O |

In this case the composition data in mol % with respect to the base glasses are multiplied as a column vector with the matrix (on the right side thereof):

TABLE 4
$( \begin{matrix}\frac{6}{8} & 1 & \frac{6}{8} & \frac{1}{2} & \frac{1}{2} & \frac{2}{4} & \frac{4}{6} & \frac{3}{5} & \frac{5}{9} & \frac{1}{2} & \frac{1}{2} \\ 0 & 0 & 0 & 0 & 0 & 0 & \frac{1}{6} & 0 & 0 & 0 & 0 \\ 0 & 0 & 0 & 0 & 0 & \frac{1}{4} & 0 & 0 & 0 & 0 & 0 \\ \frac{1}{8} & 0 & \frac{1}{8} & 0 & 0 & 0 & 0 & 0 & \frac{2}{9} & 0 & 0 \\ 0 & 0 & 0 & 0 & 0 & 0 & 0 & \frac{1}{5} & 0 & 0 & 0 \\ 0 & 0 & 0 & 0 & \frac{1}{2} & 0 & 0 & 0 & \frac{2}{9} & 0 & 0 \\ 0 & 0 & 0 & \frac{1}{2} & 0 & 0 & 0 & 0 & 0 & 0 & 0 \\ 0 & 0 & 0 & 0 & 0 & 0 & 0 & 0 & 0 & \frac{1}{2} & 0 \\ 0 & 0 & 0 & 0 & 0 & 0 & 0 & 0 & 0 & 0 & \frac{1}{2} \\ \frac{1}{8} & 0 & 0 & 0 & 0 & \frac{1}{4} & \frac{1}{6} & \frac{1}{5} & 0 & 0 & 0 \\ 0 & 0 & \frac{1}{8} & 0 & 0 & 0 & 0 & 0 & 0 & 0 & 0\end{matrix} ) \times ( \begin{matrix}( {Na}_{2} O \cdot {Al}_{2} {O}_{3} \cdot 6 {SiO}_{2} ) / 8 \\ {SiO}_{2} \\ ( {K}_{2} O \cdot {Al}_{2} {O}_{3} \cdot 6 {SiO}_{2} ) / 8 \\ ( Ca O \cdot {SiO}_{2} ) / 2 \\ ( Mg O \cdot {SiO}_{2} ) / 2 \\ ( {Na}_{2} O \cdot {Zr O}_{2} \cdot 2 {SiO}_{2} ) / 4 \\ ( {Na}_{2} O \cdot {Ti O}_{2} \cdot 4 {SiO}_{2} ) / 6 \\ ( {Na}_{2} O \cdot ZnO \cdot 3 {SiO}_{2} ) / 5 \\ ( 2 Mg O \cdot 2 {Al}_{2} {O}_{3} \cdot 5 {SiO}_{2} ) / 9 \\ ( Sr O \cdot {SiO}_{2} ) / 2 \\ ( Ba O \cdot {SiO}_{2} ) / 2\end{matrix} )$

The result of the multiplication of the column vector with the matrix is the composition of the glass in mole percentages.

Conversely, it is possible, simply to convert a composition in mole percentages into a base glass composition via the respective inverse matrix. Here, only such base glass compositions are according to the present invention which, when converted, do not result in negative values for the base glasses.

With respect to the phases constituting the glass, the composition is selected within the limits described here. In the glass product the phases constituting the glass are as such not present in crystalline form, but in amorphous form. But this does not mean that the constituent phases in the amorphous state are characterized by completely different assemblies compared to the crystalline state. As mentioned above, the topology of the assemblies is comparable, thus e.g. the coordination of the cations involved with surrounding oxygen atoms or the distance between the atoms which results from this coordination and the strength of the bond between these cations and surrounding oxygen atoms. Therefore, a lot of properties of the glass provided according to the invention can be described very well on the basis of the constituent phases, in particularly for illustrating the inventive effort and the problems which can be overcome with the invention (for that, cf. Conradt R., loc. cit.). Here, the glass cannot only be produced by using the respective crystals, but also by using the common glass raw materials, as long as the stoichiometric ratios allow the formation of the respective assemblies of the base glasses.

The selection of the phases is conducted with respect to suitability for ion transport or a supporting influence onto the ion transport as well as their influence onto the hydrolytic resistance as well as the thermal expansion. In the following, calculation methods are described with which these parameters can be calculated from a given composition out of constituent phases. These calculation methods are significant for both the selection of the constituent phases and also the composition of a glass provided according to the present invention out of these constituent phases.

Both the hydrolytic resistance according to ISO 719/720 and also the alkali resistance according to ISO 695 basically comprise a resistance of the glass against the attack of hydroxyl ions. Here, in the case of ISO 695, the concentration of the hydroxyl ions in the base is determined by the fact that a buffer solution with 0.5 mole/1 of sodium hydroxide and 0.25 mole/1 of sodium carbonate is used. In the case of ISO 719/720 the glass is placed in neutral water, wherein the pH value thereof is at first adjusted to 5.5 (verified by a methyl red indicator solution), but by the dissolution of the glass very quickly the pH value shifts into the alkaline range. A buffer solution of the weak acids (and/or acid anhydrides), above all silicic acid, and the strong bases (such as sodium hydroxide) which are contained in the glass, wherein the pH value thereof is in the range of 9 to 10, results, see Susanne Fagerlund, Paul Ek, Mikko Hupa and Leena Hupa: On determining chemical durability of glasses, Glass Technol.: Eur. J. Glass Sci. Technol. A, December 2010, 51 (6), 235-240. Essential for the pH value of a buffer solution are the pKa values of the weak acid(s). The concentration of the hydroxyl ions is determined by the pH value of the accruing buffer solution which, on the one hand, depends on the type of the glass and, on the other hand, increases during the course of the dissolution process. Then, the dissolution which is effected by these hydroxyl ions takes place according to the same mechanism like in the case of the measurement of the alkali resistance.

Thus, for reaching both, making a glass resistant against bases and also hydrolytically resistant, it is at first necessary to achieve that the removal rate during the test according to ISO 695 has a low value. On the other hand, the pH value which results during a test according to ISO 719/720 and the thereby occurring dissolution of a certain amount of glass in the aqueous test solution has to be limited. A higher pH value during the course of the test results in a higher risk of a positive feedback effect: with an increasing pH value also the removal rate increases, with an increasing amount of removal material in the aqueous solution in turn the pH value thereof increases, etc.

During the test, chemically stable glasses (hydrolytic class HGB I according to ISO 719 or hydrolytic class HGA I according to ISO 720) typically are subject to a removal which results in up to 100 μmole of glass in the aqueous solution, wherein generally a lower removal results in a less congruent removal.

Since a comparison of glasses has to refer to fixed conditions, the significant pH value is defined as that pH value which results in neutral water after a congruently supposed dissolution of 50 μmole of glass.

In some embodiments there are provided glasses for which this pH value is lower than 9.1, such as lower than 9.05 or lower than 9.0.

According to some embodiments provided according to the present invention, the removal rate according to ISO 695 may be at most 105 mg/(dm²3 h), such as at most 100 mg/(dm²3 h), at most 95 mg/(dm²3 h), at most 90 mg/(dm²3 h), or at most 85 mg/(dm²3 h). Here, the removal rate which can be calculated with the help of the formulas (2) and (3) for glasses provided according to the invention is meant.

Already the first aforementioned value is below (in an extent of more than a half of the class width) the limit between the base classes 2 and 3 according to ISO 695. With intent such a high distance is chosen so that also in the case of optional tolerances of the prediction accuracy of the formulas (2) and (3) there is still a large safety distance to class 3.

According to the present invention, the coefficient of thermal expansion may be between 4 and 8 ppm/K, such as between 4.5 and 7 ppm/K or between 4.8 and 6.5 ppm/K. Here, the value CTE which can be calculated with the help of formula (8) for glasses provided according to the invention is meant.

With respect to the removal rate in acid according to DIN 12116 it can be said that it in the case of the glasses provided according to the present invention with a characteristic number of <200 such as defined below corresponds to an acid class 3 and lower and that it in the case of a characteristic number of >215 quickly increases, with removal values which are partly several decimal powers above the limit between the classes 3 and 4. Between, there is a transition region. In some embodiments, the glass has a characteristic number of <200, such as <199, <198, <197, <196, or <195.

The calculation of the pH value in aqueous solution is based on the information regarding the composition of ordinary oxides. In the diluted solution of the glass constituents the respective cations convert into the hydroxides with the highest oxidation state. See Table 5. The release of an H⁺ or OH⁻ of these hydroxides is described by a respective pKa or pKb value each.

Here, reference is made to the pH value which after dissolution of 50 μmole in one liter of the aqueous solution after cooling to room temperature (25° C.) prevails.

TABLE 5

| | Oxide or | Acid or | | |
|---|---|---|---|---|
| # | anhydride | hydroxide | | |
| 1. | SiO₂ | H₄SiO₄ | H₄SiO₄ → H₃SiO₄⁻ + H⁺ | pKa = 9.7 ¹) |
| | | | H₃SiO₄⁻ → H₂SiO₄⁻² + H⁺ | pKa = 11.9 ¹) |
| 2. | ZrO₂ | Zr(OH)₄ | Zr(OH)₄ + H₂O → Zr(OH)₅⁻ + H⁺ | pKa = 5.99 ²) |
| | | | Zr(OH)₃⁺ + H₂O → Zr(OH)₄ + H⁺ | pKa = 4.6 ²) |
| 3. | Al₂O₃ | Al(OH)₃ | Al(OH)₃ + H₂O → Al(OH)₄⁻ + H⁺ | pKa = 12.3 ³) |
| | | | Al(OH)₂⁺ + H₂O → Al(OH)₃ + H⁺ | pKa = 5.7 ³) |
| 4. | ZnO | Zn(OH)₂ | Zn⁺² + H₂O → ZnOH⁺ + H⁺ | pKa = 9.05 ⁴) |
| | | | ZnOH⁺ + H₂O → Zn(OH)₂ + H⁺ | pKa = 9.75 ⁴) |
| | | | Zn(OH)₂ + H₂O → Zn(OH)₃⁻ + H⁺ | pKa = 10.1 ⁴) |
| | | | Zn(OH)₃⁻ + H₂O → Zn(OH)₄⁻ + H⁺ | pKa = 10.05 ⁴) |
| 5. | MgO | Mg(OH)₂ | Mg(OH)₂ → Mg(OH)⁺ + OH⁻ | pKb = −2 ⁵) |
| | | | Mg(OH)⁺ → Mg⁺⁺ + OH⁻ | pKb = 2.58 ⁶) |
| 6. | CaO | Ca(OH)₂ | Ca(OH)₂ → Ca(OH)⁺ + OH⁻ | pKb = −2 ⁵) |
| | | | Ca(OH)⁺ Ca⁺⁺ + OH⁻ | pKb = 1.3 ⁷) |
| 7. | Na₂O | NaOH | NaOH → Na⁺ + OH⁻ | pKb = −0.77 ¹⁰) |
| 8. | K₂O | KOH | KOH → K⁺ + OH⁻ | pKb = −2 ¹¹) |
| 10. | SrO | Sr(OH)₂ | Sr(OH)₂ → Sr(OH)⁺ + OH⁻ | pKb = −2 ⁵) |
| | | | Sr(OH)⁺ → Sr⁺⁺ + OH⁻ | pKb = 0.82 ¹²) |
| 11. | BaO | Ba(OH)₂ | Ba(OH)₂ → Ba(OH)⁺ + OH⁻ | pKb = −2 ⁵) |
| | | | Ba(OH)⁺ → Ba⁺⁺ + OH⁻ | pKb = 0.64 ¹³) |

¹) Pure Appl. Chem., 1969, Vol. 20, No. 2, pp. 133-236, numeral 176; value of the source being called “G40” there.
²) R. H. Byrne, Inorganic speciation of dissolved elements in seawater: the influence of pH on concentration ratios, Geochem. Trans. 3 (2) (2002) 11-16.
³) David W. Hendricks, Water Treatment Unit Processes: Physical and Chemical, CRC Taylor and Francis, Boca Raton, London, New York, 2006, p. 307; values of the sources being called “4”, “5”, “11”, “12” there.
⁴) Artur Krezel, Wolfgang Maret, The biological inorganic chemistry of zinc ions, Archives of Biochemistry and Biophysics (2016), p. 1-17
⁵) Like in the case of barium hydroxide, see Pure Appl. Chem., 1969, Vol. 20, No. 2, pp. 133-236, numeral 12, it is assumed that M(OH)₂ → M(OH)⁺ + OH⁻ for all alkaline earths M in any case completely proceeds; for this first dissociation as pKb value the highest pKb value being present in this table is used, namely that one of potassium hydroxide solution.
⁶) Pure Appl. Chem., 1969, Vol. 20, No. 2, pp. 133-236, numeral 115; value of the source being called “S74” there.
⁷) Pure Appl. Chem., 1969, Vol. 20, No. 2, pp. 133-236, numeral 18; value of the source being called “D9” there.
¹⁰) Pure Appl. Chem., 1969, Vol. 20, No. 2, pp. 133-236, numeral 178; value of the source being called “G26” there.
¹¹) Pure Appl. Chem., 1969, Vol. 20, No. 2, pp. 133-236, numeral 164; value of the source being called “K2” there.
¹²) Pure Appl. Chem., 1969, Vol. 20, No. 2, pp. 133-236, numeral 180; value of the source being called “G26” there.
¹³) Pure Appl. Chem., 1969, Vol. 20, No. 2, pp. 133-236, numeral 12; value of the source being called “D7” there.

The pH value, in the case of a given composition, can be obtained by solving the equation system for the different concentrations (for pKa and pKb the above listed values have to be used):

Equation system (1)

[H₂SiO₄⁻⁻][H⁺]/[H₃SiO₄⁻]=10^{-pKa}, 1.

[H₃SiO₄⁻][H⁺]/[H₄SiO₄]=10^{-pKa}, 2.

[H₂SiO₄⁻⁻]+[H₃SiO₄⁻]+[H₄SiO₄]=50 (μmole/l)*c_{SiO2}, 3.

[Zr(OH)₅⁻][H⁺]/[Zr(OH)₄]=10^{-pKa}, 4.

[Zr(OH)₄][H⁺]/[Zr(OH)₃^{+]=}10^{-pKa}, 5.

[Zr(OH)₅⁻]+[Zr(OH)₄]+[Zr(OH)₃⁺]=50 (μmole/l)*c_{ZrO2}, 6.

[Al(OH)₄⁻][H⁺]/[Al(OH)₃]=10⁻pKa 7.

[Al(OH)₃][H+]/[Al(OH)₂+]=10^{-pKa}_{,} 8.

[Al(OH)₄⁻]+[Al(OH)₃]+[Al(OH)₂⁺]=50 (μmole/l)*2*c_{Al2O3}, 9.

[ZnOH⁺][H⁺]/[Zn++]=10^{-pKa}, 10.

[Zn(OH)₂]/[ZnOH⁺]=10^{-pKa}, 11.

[Zn(OH)₃⁻][H⁺]/[Zn(OH)₂]=10^{-pKa}, 12.

[Zn(OH)₄⁻⁻][H⁺]/[Zn(OH)₃⁻]=10^{-pKa}, 13.

[ZnOH⁺]+[Zn⁺⁺]+[Zn(OH)₂]+[Zn(OH)₃⁻]+[Zn(OH)₄⁻⁻]=50 (μmole/l)*c_{ZnO}, 14.

[MgOH⁺][OH⁻]/[Mg(OH)₂]=10^{-pKb} 15.

[Mg⁺⁺][OH⁻]/[MgOH⁺]=10^{-pKb,} 16.

[MgOH⁺]+[Mg(OH)₂]+[Mg⁺⁺]=50 (μmole/l)*c_{MgO}, 17.

[CaOH⁺][OH⁻]/[Ca(OH)₂]=10^{-pKb} 18.

[Ca⁺⁺][OH⁻]/[CaOH⁺]=10^{-pKb}, 19.

[CaOH⁺]+[Ca(OH)₂]+[Ca⁺+]=50 (μmole/l)*c_{CaO}, 20.

[SrOH⁺][OH⁻]/[Sr(OH)₂]=10^{-pKb} 21.

[Sr⁺⁺][OH⁻]/[SrOH⁺]=10^{-pKb}, 22.

[SrOH⁺]+[Sr(OH)₂]+[Sr⁺+]=50 (μmole/l)*c_{SrO}, 23.

[BaOH⁺][OH⁻]/[Ba(OH)₂]=10^{-pKb} 24.

[Ba⁺⁺][OH⁻]/[BaOH⁺]=10^{-pKb}, 25.

[BaOH⁺]+[Ba(OH)₂]+[Ba⁺⁺]=50 (μmole/l)*c_{BaO,} 26.

[Na⁺][OH⁻]/[NaOH]=10^{-Pkb}, 27.

[Na⁺]+[NaOH]=50 (μmole/l)*2*c_{Na2O}, 28.

[k⁺][OH⁻]/[KOH]=10^{-pKb}, 29.

[K⁺]+[KOH]=50 (μmole/l)*2*c_{K2O}, 30.

[OH⁻][H⁺]=10⁻¹⁴, 31.

2*[H₂SiO₄⁻⁻]+[H₃SiO₄⁻]+[Zr(OH)₅⁻]+[Al(OH)₄⁻]+2*[Zn(OH)₄⁻⁻]+[Zn(OH)₃⁻]+[OH⁻]=[Zr(OH)₃⁺]+[Al(OH)₂⁺]+2*[Zn⁺+]+[ZnOH⁺]+2*[Ba⁺⁺][BaOH⁺]+2*[Sr⁺⁺]+[SrOH⁺]+2*[Ca⁺⁺]+[CaOH⁺]+2*[Mg⁺⁺]+[MgOH⁺]+[Na⁺]+[K⁺]+[H⁺] 32.

The equations 1-31 are equilibrium conditions, and equation 32 is the condition of electroneutrality.

The equation system can uniquely be solved with one of the common mathematical codes such as e.g. MATHEMATICA of Wolfram Research Inc. MATHEMATICA provides a list of solutions, wherein however only one of them fulfills the required supplementary condition that all concentrations have to be positive.

According to the definition, the pH value is the negative decadic logarithm of [W]. Also, at room temperature the following is true: pKa+pKb=14.

Exemplary embodiments provided according to the invention are based on the surprisingly found relationship between a parameter being construed with the help of topological considerations and the removal rate being measured in the test according to ISO 695.

The base of topological considerations is to count the constraints which are imposed on the atoms by the bond to the neighbor atoms, such as for example explained in detail in DE 10 2014 119 594 A1. These constraints relate, on the one hand, to the interatomic distance (“distance conditions”) and, on the other hand, to the bond angles (“angle conditions”). When an atom has r neighbors (r=coordination number), then from the r distance conditions to these neighbors r/2 distance conditions to be assigned to this atom follow, when the distance conditions are equally distributed under both binding partners. From the bond angles between these neighbors, with the considered atom at the tip of the respective angle, further 2r-3 angle conditions follow which have to be assigned to this atom.

In DE 10 2014 119 594 A1 a method is described in which in the calculation of the distance and angle conditions a weighting of all conditions with the single bond strength and once again an additional weighting of the angle conditions (only those arising from the oxygen/cation/oxygen angles; the conditions arising from the cation/oxygen/cation angles are disregarded) with the covalence number of the respective bond are involved. Here, the weighting factors are normalized by respectively dividing by the single bond strength or the covalence number of the silicon-oxygen bond so that for quartz glass a number of (rounded) 1.333333333 (i.e. 4/3) distance conditions and (rounded) 1.666666667 (i.e. 5/3) angle conditions per atom result. This corresponds, such as explained in DE 10 2014 119 594 A1, to the direct analysis of the topology of quartz glass, when all distance and angle conditions are counted once and the angle conditions of the silicon/oxygen/silicon angles are disregarded.

Thus, quartz glass is characterized by a number of “3” constraints per atom which exactly corresponds to the number of freedom degrees per atom. Thus, quartz glass should not have any (or in reality: a very low) number of freedom degrees per atom which corresponds to the small cₚ transition of quartz glass, when the glass transition is measured by differential scanning calorimetry, see R. Brüning, “On the glass transition in vitreous silica by differential thermal analysis measurements”, Journal of Non-Crystalline Solids 330 (2003) 13-22.

Generally, for other oxidic glasses lower values for the numbers of the distance and angle conditions per atom than (rounded) 1.333333333 (4/3) and 1.666666667 (5/3) result. Correspondingly, the differences are the numbers of the freedom degrees of distances and angles per atom. In the case of the freedom degrees of angles it is possible to distinguish between angle conditions relating to angles which all are in one plane (trigonal coordination) or not (tetrahedral or higher coordination). Here, the latter are referred to as 3D angle conditions; correspondingly, the difference to (rounded) 1.666666667 (4/3) as 3D freedom degrees of angles.

Surprisingly, it was found that there is a relationship between the number of the 3D freedom degrees of angles per atom and the removal rate r in the ISO 695 test with which the classes of the alkali resistance of a glass can be assessed. This relationship which is especially optimized for use also in the case of glasses with high alkali content and which has shown good results in numerous tests of glasses is as follows:

$$r = c \cdot ( \frac{M}{{M}_{{SiO}_{2}}} \cdot \frac{N}{{N}_{{SiO}_{2}}} ) \cdot ( {( 1 + f )}^{6} + {c}^{′} ) \cdot ( 0.9483333 - Λ ) \qquad ( 2 )$$

“c” is a constant with the dimension mg/(dm²3 h); the numerical value is 163.9. “f” is the number of the 3D freedom degrees of angles per atom. “c” is a constant without dimension with a value of 1.8. The exponent “6” was found empirically. A is the optical basicity.

The factor N/N_{SiO2} is used for the conversion of one atom group for which the above probability consideration has been made into one mole. N is the number of the atoms per mole. N_{SiO2} is the number of the atoms per mole quartz glass (namely 3N_{A}, N_{A} Avogadro number) and is used for the normalization of this term. Without blundering, it is possible to use this factor as a constant and to combine this constant with the prefactor “c”, when this is only made within a clearly defined glass family. The factor M/M_{SiO2} is used for the conversion of the above consideration of one atom into a mass consideration. M is the mass of one mole. M_{SiO2} is the mass of one mole quartz glass (namely 60.08 g) and is used for the normalization of this term. It is also possible, without blundering, to use this factor as a constant and to combine this constant with the prefactor “c”, when this is only made within a clearly defined glass family.

As already mentioned, the relationship between removal rate and number of the 3D freedom degrees of angles was found empirically, but it seems plausible, when it is considered that the kinetic of the penetration of OH⁻ ions into the glass depends on the entropy of the glass. It is not assumed that the factor (0.9483333-A) is linked with the kinetic of the process, but with the driving force of the acid/base reaction which occurs in the context of the dissolution of the glass in the lye.

TABLE 6

| | | | | Number of the |
|---|---|---|---|---|
| | | | Number of | 3D freedom |
| | | Molar | atoms per | degrees of |
| Constituent phase | Stoichiometry | mass/g | assembly | angles per atom |
| albite | (Na₂O•Al₂O₃•6SiO₂)/8 | 65.5558 | 3.2500 | 0.318898019 |
| silicon dioxide | SiO₂ | 60.08 | 3.0000 | 0 |
| orthoclase | (K₂O•Al₂O₃•6SiO₂)/8 | 69.5829 | 3.2500 | 0.322595955 |
| wollastonite | (CaO•SiO₂)/2 | 58.08 | 2.5000 | 0.573505131 |
| enstatite | (MgO•SiO₂)/2 | 50.19 | 2.5000 | 0.541903867 |
| parakeldyshite | (Na₂O•ZrO₂•2SiO₂)/4 | 76.3416 | 3.0000 | 0.5871628 |
| narsarsukite | (Na₂O•TiO₂•4SiO₂)/6 | 63.7025 | 3.0000 | 0.379385407 |
| disodium zinc | (Na₂O•ZnO•3SiO₂)/5 | 64.7222 | 2.8000 | 0.52778666 |
| silicate | | | | |
| cordierite | (2MgO•2Al₂O₃•5SiO₂)/9 | 64.9948 | 3.2222 | 0.427525472 |
| strontium silicate | (SrO•SiO₂)/2 | 81.437 | 2.5000 | 0.599379939 |
| barium silicate | (BaO•SiO₂)/2 | 106.7065 | 2.5000 | 0.60607952 |

The numerical values were calculated according to the method given in DE 10 2014 119 594 A1, wherein here the number of the freedom degrees of angles for all cations was calculated, namely like in DE 10 2014 119 594 A1 (but there only for boron and aluminum); in addition, the degree of ionization of a cation-oxygen compound was not calculated according to formula (8) of DE 10 2014 119 594 A1, but according to formula (3) of Alberto Garcia, Marvon Cohen, First Principles Ionicity Scales, Phys. Rev. B 1993. For that further information about the coordination number of the respective cation is required, wherein here according to Conradt, loc.cit., the coordination number of the respective constituent phase is used (when a cation is present in several coordination numbers, then a mean value of the different coordination numbers which corresponds to the respective proportions is used). The mentioned coordination numbers can be found in literature, for albite: American Mineralogist, Volume 61, pages 1213-1225, 1976, American Mineralogist, Volume 62, pages 921-931, 1977, American Mineralogist, Volume 64, pages 409-423, 1979, American Mineralogist, Volume 81, pages 1344-1349, 1996, wherein in view of these sources for Si and Al a coordination number of 4 and for Na a coordination number of 5 were assumed; for SiO2 the coordination number of 4 for silicon was assumed as being generally well-known; for orthoclase: Canadian Mineralogist, Volume 17, pages 515-525, 1979, wherein in view of this source for aluminum a coordination number of 4, for potassium a coordination number of 9 and for silicon a coordination number of 4 were assumed; for wollastonite: Mineralogical Society of America, Special Paper 1, pages 293-302, 1963, wherein in view of this source for silicon a coordination number of 4 and for calcium a coordination number of 6 were assumed; for enstatite: Canadian Mineralogist Vol. 37, pp 199-206, 1999, wherein in view of this source for silicon a coordination number of 4 and for magnesium a coordination number of 6 were assumed; for parakeldyshite: Acta Chemica Scandinavia, 1997, 51, 259-263, wherein in view of this source for silicon a coordination number of 4, for zirconium a coordination number of 6 and for sodium a coordination number of 8 were assumed; for narsarsukite: American Mineralogist 47 (1962), 539, wherein in view of this source for silicon a coordination number of 4, for titanium a coordination number of 6 and for sodium a coordination number of 7 were assumed; disodium zinc silicate: Acta Cryst. (1977), B33, 1333-1337, wherein in view of this source for silicon and zinc a coordination number of 4 and for sodium a coordination number of 7 were assumed; for cordierite: American Mineralogist, Volume 77, pages 407-411, 1992, wherein in view of this source for silicon and aluminum a coordination number of 4 and for magnesium a coordination number of 6 were assumed; for strontium silicate: Acta Cryst. C53, pages 534-536, 1997, wherein in view of this source for silicon a coordination number of 4 and for strontium a coordination number of 8 were assumed; for barium silicate: Wolfram Hempel: Struktureigenschaftsbeziehungen in Erdalkalisilikat basierenden Leuchtstoffen, thesis, Physics, University of Augsburg, 2007, wherein in view of this source for silicon a coordination number of 4 and for barium a coordination number of 8 were assumed.

Thus, the calculation specification for the determination of the 3D freedom degrees of angles f per atom in the final glass is as follows:

$$f = \frac{{\sum }_{i = 1}^{n} {c}_{i} \cdot {z}_{i} \cdot {f}_{i}}{{\sum }_{i = 1}^{n} {c}_{i} \cdot {z}_{i}} , \qquad ( 3 )$$

wherein cᵢ is the molar proportion of the ith constituent phase in the considered glass composition, zᵢ is the number of atoms per assembly in the ith constituent phase (or the number of atoms per mole in the ith constituent phase; then in units of N_{A}, N_{A} Avogadro number) and fᵢ is the number of the freedom degrees of angles per atom in the ith constituent phase. “n” is the number of the constituent phases.

The calculation specification for the determination of M/M_{SiO2} is as follows:

$$\frac{M}{{M}_{{SiO}_{2}}} = \frac{{\sum }_{i = 1}^{n} {c}_{i} \cdot {M}_{i}}{{M}_{{SiO}_{2}} \cdot {\sum }_{i = 1}^{n} {c}_{i}} , \qquad ( 4 )$$

wherein cᵢ is the molar proportion of the ith constituent phase in the considered glass composition and n is the respective molar mass, “n” is the number of the constituent phases.

The calculation specification for the determination of N/N_{SiO2} is as follows:

$$\frac{N}{{N}_{{SiO}_{2}}} = \frac{{\sum }_{i = 1}^{n} {c}_{i} \cdot {z}_{i}}{3 \cdot {\sum }_{i = 1}^{n} {c}_{i}} , \qquad ( 5 )$$

wherein cᵢ is the molar proportion of the ith constituent phase in the considered glass composition and zᵢ is the number of atoms per assembly in the ith constituent phase (or the number of atoms per mole in the ith constituent phase; then in units of N_{A}, N_{A} Avogadro number), “n” is the number of the constituent phases.

The following consideration results in the finding that there is a relationship between the factor (0.9483333-Λ) and the driving force of the dissolution. This driving force is higher, when the glass is “more acidic”, i.e. when the proportion of acid anhydrides is higher and when the proportion of alkali anhydrides is lower. A quantitative measure for that is the optical basicity, see C. P. Rodriguez, J. S. McCloy, M. J. Schweiger, J. V. Crum, A, Winschell, Optical Basicity and Nepheline Crystallization in High Alumina Glasses, Pacific Northwest National Laboratories, PNNL 20184, EMSP-RPT 003, prepared for the US Department of Energy under contract DE-AC05-76RL01830. When the optical basicity is lower, then the driving force is higher. The fact that the “driving force is zero” is true for a material in which the acid/base reaction is completed. The latter case is in particularly assumed, when the glass has the stoichiometry of sodium metasilicate, thus that one under all sodium silicates which are solids having the highest proportion of sodium. Sodium orthosilicate only appears in aqueous solution. Its optical basicity according to the method for the calculation of it described below is exactly 0.9483333, thus the value with which per constructionem the aforementioned factor (0.9483333-A) becomes zero.

The optical basicity A is calculated according to formula B.1 with the coefficient Λ_{χ}av (optical basicity according to Li and Xue) according to paragraph B.1.6 and table B.1 of C. P. Rodriguez, J. S. McCloy, M. J. Schweiger, J. V. Crum, A, Winschell, Optical Basicity and Nepheline Crystallization in High Alumina Glasses, Pacific Northwest National Laboratories, PNNL 20184, EMSP-RPT 003, prepared for the US Department of Energy under contract DE-AC05-76RL01830. When in the table for an ordinary oxide only one coefficient is given, then this coefficient is used. When in the table for one ordinary oxide several coefficients are given, then the coefficient which applies to the coordination numbers of the respective cation in the constituent phases is used. For the above described base system this is only necessary in the case of aluminum oxide and magnesium oxide. Since aluminum has in all constituent phases of the base system a coordination number of 4 and since according to Conradt, loc. cit., it is also assumed that, for the coefficient Λ_{ICP} the value which is given in table B.1 in the case of aluminum oxide for the coordination number of 4 is used. Since magnesium in the only magnesium containing constituent phase of the base system has a coordination number of 6, for the coefficient Λ_{χ}av the value which is given in table B.1 in the case of magnesium oxide for the coordination number of 6 is used.

Surprisingly, it is also possible to assess the acid resistance with the help of a characteristic number which can easily be calculated. The starting point for the basic considerations associated therewith is the theory of Anderson and Stuart about the ion mobility in siliceous glasses, see O. L. Anderson, D. A. Stuart, Calculation of Activation Energy of Ionic Conductivity in Silica Glasses by Classical Methods, Journal of the American Ceramic Society, Vol. 37, No. 12 (1954), 573-580. According to that the activation energy of the movement of a cation in a siliceous and thus oxidic glass depends, on the one hand, on the electrostatic interaction with the surrounding oxygen ions which has to be overcome and, on the other hand, on the mechanical resistance which has to be overcome, when they relocate from one mesh of the siliceous network into the next. The first mentioned contribution according to Coulomb's law is proportional to the charge number of the considered cation and inversely proportional to the dielectric constant, the second mentioned contribution is proportional to the shear modulus and to the power of two of the value of the measure by which the diameter of the considered cation exceeds the mesh width of the network. Due to the first mentioned contribution, inter alia, only singly charged cations are mobile and multiply charged cations such as aluminum are stationary.

In contact with a highly concentrated acid, according to ISO 1776 and DIN 12116 this is 6N hydrochloric acid, this is different. In this case protons or hydronium ions diffuse into the glass and form at the surface with the chloride ions which remain in the acid bath an electric double layer. An analysis of the eluate comprising measurements according to ISO 1776 has shown that this electric double layer is formed in such an extent that the electric field originating from that is capable of compensating the electrostatic interaction of the respective cation with the surrounding oxygen ions so that also ions with high charge number become mobile. The force action of the electric field of the mentioned double layer, just as the electrostatic interaction of the considered cation, depends on its charge number; therefore, the first one may be capable of compensating the last one.

This may result in the fact that under the same test conditions (those of ISO 1776) much more aluminum ions leave an alkali-free display glass than sodium ions a soda-lime glass. On the other hand, again under the same test conditions less boron atoms leave a borosilicate glass than aluminum atoms an aluminosilicate glass. This can be understood, when the following is considered: due to the different values of electronegativity, boron or also silicon show a considerably lower tendency to react with hydrochloric acid than aluminum or sodium. The reaction of sodium oxide with hydrochloric acid is a reaction of a strong base or a strong base anhydride with a strong acid, aluminum as an amphoteric substance is in the middle and boron oxide or silicon oxide are the anhydrides of weak acids.

The tendency of a cation to leave the glass composite can be deduced from the degree of ionization of the respective cation-oxygen compound which is calculated according to the formula (3) of Alberto Garcia, Marvon Cohen, First Principles Ionicity Scales, Phys. Rev. B 1993.

For that further information about the coordination number of the respective cation is required, wherein here according to Conradt, loc.cit., the coordination number of the respective constituent phase is used (when a cation is present in several coordination numbers, then a mean value of the different coordination numbers which corresponds to the respective proportions is used). The mentioned coordination numbers can be found in literature, for albite: American Mineralogist, Volume 61, pages 1213-1225, 1976, American Mineralogist, Volume 62, pages 921-931, 1977, American Mineralogist, Volume 64, pages 409-423, 1979, American Mineralogist, Volume 81, pages 1344-1349, 1996, wherein in view of these sources for Si and A1 a coordination number of 4 and for Na a coordination number of 5 were assumed; for SiO₂ the coordination number of 4 for silicon was assumed as being generally well-known; for orthoclase: Canadian Mineralogist, Volume 17, pages 515-525, 1979, wherein in view of this source for aluminum a coordination number of 4, for potassium a coordination number of 9 and for silicon a coordination number of 4 were assumed; for wollastonite: Mineralogical Society of America, Special Paper 1, pages 293-302, 1963, wherein in view of this source for silicon a coordination number of 4 and for calcium a coordination number of 6 were assumed; for enstatite: Canadian Mineralogist Vol. 37, pp 199-206, 1999, wherein in view of this source for silicon a coordination number of 4 and for magnesium a coordination number of 6 were assumed; for parakeldyshite: Acta Chemica Scandinavia, 1997, 51, 259-263, wherein in view of this source for silicon a coordination number of 4, for zirconium a coordination number of 6 and for sodium a coordination number of 8 were assumed; for narsarsukite: American Mineralogist 47 (1962), 539, wherein in view of this source for silicon a coordination number of 4, for titanium a coordination number of 6 and for sodium a coordination number of 7 were assumed; disodium zinc silicate: Acta Cryst. (1977), B33, 1333-1337, wherein in view of this source for silicon and zinc a coordination number of 4 and for sodium a coordination number of 7 were assumed; for cordierite: American Mineralogist, Volume 77, pages 407-411, 1992, wherein in view of this source for silicon and aluminum a coordination number of 4 and for magnesium a coordination number of 6 were assumed; for strontium silicate: Acta Cryst. C53, pages 534-536, 1997, wherein in view of this source for silicon a coordination number of 4 and for strontium a coordination number of 8 were assumed; for barium silicate: Wolfram Hempel: Struktureigenschaftsbeziehungen in Erdalkalisilikat basierenden Leuchtstoffen, thesis, Physics, University of Augsburg, 2007, wherein in view of this source for silicon a coordination number of 4 and for barium a coordination number of 8 were assumed.

When the degree of ionization of the compound (degree of ionization according to Pauling, calculated according to formula (3) of Alberto Garcia, Marvon Cohen, First Principles Ionicity Scales, Phys. Rev. B 1993, s.a.) is multiplied by the valence number or valency of the cation, then a characteristic number is obtained which describes the destruction of the network being caused by fact that the cation leaves the network. The valency of the cation is the number of the hydronium ions which are necessary due to electroneutrality reasons for substituting the cation. Each hydronium ion destroys one and a half oxygen bridges in the glass, which then in the case of an acidic attack results in the observed gel formation, see e.g. T. Geisler, A. Janssen, D. Scheiter, T. Stephan, J. Berndt, A. Putnis, Aqueous corrosion of borosilicate glass under acidic conditions: A new corrosion mechanism, Journal of Non-Crystalline Solids 356 (2010) 1458-1465.

Multiplication of the respective characteristic number by the number of moles of the considered cation in one mole of glass and summation over all cations result in a characteristic number for the extent of the destruction of the network which is initially caused by an acidic attack onto the glass. So, in particularly, characteristic numbers for the glasses which are produced from one constituent phase each are obtained. When the partition of the glass with respect to the constituent phases is known, then the proportion of the constituent phase each given in mole percentages is multiplied by the last mentioned characteristic number (phase), and subsequently a summation over all constituent phases is made.

Remarkably, as already mentioned above, a clear correlation with the acid classes according to DIN 12116 is found; wherein in the range of characteristic numbers of 190-210 the acid class strongly increases from 1 to 4. Accordingly, a characteristic number which is as low as possible is desirable.

In the following, for the constituent phases of the base glass system provided according to the present invention the characteristic numbers kᵢ are tabulated so that the characteristic number of a glass provided according to the present invention can be calculated with the help of the following formula:

$$k = \frac{{\sum }_{i = 1}^{n} {c}_{i} \cdot {k}_{i}}{{\sum }_{i = 1}^{n} {c}_{i}} \qquad ( 6 )$$

Here, n is the number of the constituent phases, cᵢ is the respective molar proportion (mole percentage/100).

TABLE 7

| | | |
|---|---|---|
| albite | (Na₂O•Al₂O₃•6SiO₂)/8 | 208.797171 |
| silicon dioxide | SiO₂ | 178.9111743 |
| orthoclase | (K₂O•Al₂O₃•6SiO₂)/8 | 209.3328332 |
| wollastonite | (CaO•SiO₂)/2 | 181.9311358 |
| enstatite | (MgO•SiO₂)/2 | 178.7332098 |
| parakeldyshite | (Na₂O•ZrO₂•2SiO₂)/4 | 220.9573858 |
| narsarsukite | (Na₂O•TiO₂•4SiO₂)/6 | 200.2637459 |
| disodium zinc | (Na₂O•ZnO•3SiO₂)/5 | 176.7133128 |
| silicate | | |
| cordierite | (2MgO•2Al₂O₃•5SiO₂)/9 | 229.1163552 |
| strontium silicate | (SrO•SiO₂)/2 | 184.1495204 |
| barium silicate | (BaO•SiO₂)/2 | 184.535871 |

Surprisingly, it is also possible to describe the position of the coefficient of thermal expansion within the intended range with the help of a very simple calculation specification. It results from the mean bond strength.

From literature is known that the coefficient of thermal expansion e.g. for metals is inversely proportional to the binding energy (or to the “depth of the interatomic potential wells”), see e.g. H. Föll, lecture script “Einführung in die Materialwissenschaft I”, Christian Albrechts-Universität Kiel, p. 79-83.

In a simple picture of oxidic glasses the cations are placed in one potential well each being formed by the surrounding oxygen atoms, and for its depth the sum of the bond strengths of the different single bonds to the surrounding oxygen atoms is assumed, thus the whole interaction energy is concentrated in potential wells with the cations in the center and the oxygen atoms in the periphery. So it is not necessary to consider the reverse case; and it would also be more difficult to analyze it, because it is possible that an oxygen atom is located between several different cations, which reversely cannot occur in the case of purely oxidic glasses. These values are tabulated e.g. in DE 10 2014 119 594 A1:

TABLE 8

| | Depth of potential well/ |
|---|---|
| Cation | (kJ/mole) |
| Si | 1864 |
| Ti | 1913 |
| Zr | 2204 |
| Al | 1537 |
| Zn | 728 |
| Mg | 999 |
| Ca | 1063 |
| Sr | 1005 |
| Ba | 976 |
| Na | 440.5 |
| K | 395 |

The values for Ti, Zr, Sr, Ba and Zn do not originate from DE 10 2014 119 594 A1, but they have been calculated according to exactly the same method described there and with the help of the sources cited there.

From the composition of a glass out of the above mentioned constituent phases, the numbers of different cations contained in the respective phases and the above tabulated depths of potential wells per cation a mean depth of a potential well can be calculated:

$$\overline{{E}_{pot}} = \frac{{\sum }_{i = 1}^{n} {c}_{i} \cdot {\sum }_{j = 1}^{m} {z}_{i , j} \cdot {E}_{pot , j}}{{\sum }_{i = 1}^{n} {c}_{i} \cdot {\sum }_{j = 1}^{m} {z}_{i , j}} , \qquad ( 7 )$$

Here, m is the number of the present types of cations, E_{pot,j} is the depth of a potential well tabulated above for the jth type of cation and z_{j,i} is the number of the cations of the jth type in the ith constituent phase. In the following, the sums over j are tabulated:

TABLE 9

| Constituent phase | Formula (normalized to an ordinary oxide) | ${\sum }_{j = 1}^{m} {z}_{i , j}$ | Σⱼ₌₁^{m} z_{i,j} · E_{pot,j}/ (kJ/mole) |
|---|---|---|---|
| albite | (Na₂O · Al₂O₃ · 6SiO₂)/8 | 1.25 | 1892.375 |
| silicon dioxide | SiO₂ | 1 | 1864 |
| orthoclase | (K₂O · Al₂O₃ · 6SiO₂)/8 | 1.25 | 1881 |
| wollastonite | (CaO · SiO₂)/2 | 1 | 1463.5 |
| enstatite | (MgO · SiO₂)/2 | 1 | 1431.5 |
| parakeldyshite | (Na₂O · ZrO₂ · 2SiO₂)/4 | 1.25 | 1703 |
| narsarsukite | (Na₂O · TiO₂ · 4SiO₂)/6 | 1.166666667 | 1708.33 |
| disodium zinc silicate | (Na₂O · ZnO · 3SiO₂)/5 | 1.2 | 1440.2 |
| cordierite | (2MgO · 2Al₂O₃ · 5SiO₂)/9 | 1.222222222 | 1940.666667 |
| strontium silicate | (SrO · SiO₂)/2 | 1 | 1434.5 |
| barium silicate | (BaO · SiO₂)/2 | 1 | 1420 |

This mean bond strength, such as e.g. also in the case of metals, see H. Föll, loc. cit., is inversely proportional to the coefficient of thermal expansion. The analysis of a number of relevant glasses results in the following formula:

$$C T E = ( \frac{50082.42827 ( \frac{kJ}{mole} )}{\overline{{E}_{pot}}} -- 26.14910156 ) ppm \text{/} K , \qquad ( 8 )$$

Since the bond strength is inversely proportional to the melting point, an inverse proportionality also applies between the melting point and the expansion coefficient, see again H. Föll, loc. cit. Since in the case of non-stoichiometric glasses there is no exact definition of the melting point, between the temperature which is generally called melting point and at which the viscosity is 100 dPas and the expansion coefficient only a tendency exists. But according to this tendency it is guaranteed that the glasses provided according to the present invention are meltable.

While the requirement of good meltability suggests a coefficient of thermal expansion which is as high as possible, contrary thereto, the requirement of thermal strains which are as low as possible during an optional thermal reprocessing suggests a coefficient of thermal expansion which is as low as possible. The combination of both requirements results in the sometimes preferred medium range for the expansion coefficient and/or the mean depth of a potential well.

For guaranteeing an optimum exchangeability, the content of sodium oxide of the glasses provided according to the present invention may be 3 mol % to 12 mol %. Here, the molar proportion of this oxide after converting the composition into the respective oxide composition is meant.

Furthermore, for guaranteeing a high exchangeability, due to the relationship to the coefficient of thermal expansion a high value thereof is intended, see Journal of Non-Crystalline Solids 455 (2017) 70-74. As can be followed from the aforementioned explanations with respect to the coefficient of thermal expansion, it is increased, in particularly, by the addition of alkali or alkaline earth ions. This results also, as in turn can be followed from the aforementioned explanations with respect to the alkali resistance, due to the relationship to the driving force in the case of dissolution in alkaline medium, in high alkali resistance. But this also results in an increase of the pH value which is determined according to the aforementioned regulations, which in turn decreases the hydrolytic resistance.

Therefore, sometimes preferable according to the present invention are glasses for which the quotient of the coefficient of thermal expansion multiplied by 1000 (in ppm/K), on the one hand, and the product of the pH value and the calculated removal rate in alkaline environment (in mg/(dm²3 h)) according to ISO 695, on the other hand, is at least 7.75, such as at least 8, at least 8.25, at least 8.5, at least 8.75, at least 9, or at least 9.25. The calculated values each for the coefficient of thermal expansion, the pH value and the removal rate according to ISO 695 are meant.

Albite

A base glass which is present in the glass provided according to the invention as a constituent phase is albite glass. For ideal albite (NaAlSi₃O₈) is known that it is characterized by a high sodium diffusivity due to its structure of a skeleton of SiO₄ and AlO₄ tetrahedrons with sodium ions being mobile within the skeleton, see Geochimica et Cosmochimica Acta, 1963, Vol. 27, pages 107-120. Therefore, a proportion of albite glass makes a contribution to a high sodium mobility which supports the ion exchange and thus the chemical temperability of the glasses. In contrast to nepheline which is characterized by a still higher sodium diffusivity (artificial variant without potassium: NaAlSiO₄) albite has the advantage of a considerably lower melting point (1100-1120° C.) which improves the meltability of the glass.

An amount of albite which is too low compromises the ion exchangeability and the chemical temperability with respect to the exchange of sodium with potassium. Pure albite glass would probably be able to provide an optimum chemical temperability, but with respect to the required chemical stability, especially the acid resistance, it would not be expedient. According to the present invention, one mole of albite means one mole of (Na₂O.Al₂O₃.6SiO₂)/8.

The proportion of albite in the glass provided according to the present invention is at least 20 mol % and at most 60 mol %. Exemplary proportions in the glass provided according to the present invention are at least 25 mol %, at least 30 mol %, at least 35 mol % or at least 40 mol %. The content of albite may be at most 56 mol % or up to 50 mol %.

All components influence as hydroxides the pH value during the measurement of the hydrolytic resistance. In neutral aqueous solution and weak bases aluminum hydroxide shows poor solubility; but the solubility limit is considerably higher than the concentrations which occur during the measurements of the hydrolytic resistance.

Orthoclase

For suppressing a possible tendency to unmixing, as second phase the potassium analog of albite, orthoclase, is added. One mole of orthoclase means one mole of (K₂O.Al₂O₃.6SiO₂)/8.

The proportion of orthoclase in the glass provided according to the present invention is 0 mol % to at most 20 mol %. Exemplary proportions in the glass provided according to the present invention are at most 15 mol %, at most 10 mol % or at most 5 mol %. In some embodiments the proportion of orthoclase is at least 1 mol %, such as at least 2 mol %. In other exemplary embodiments the glass is free of orthoclase. In particularly, in some embodiments, the content of orthoclase does not exceed the content of enstatite.

All components influence as hydroxides the pH value during the measurement of the hydrolytic resistance.

Parakeldyshite

As a further phase with sodium conductivity parakeldyshite is added. As crystal parakeldyshite is a three-dimensional network of silicon tetrahedrons and zirconium octahedrons with sodium atoms in the cavities therebetween with a coordination number of 8. This zeolite-like, uncongested (very high coordination number for sodium) structure supports the ion mobility. There is a structurally related potassium analog, khibinskite, so that also an exchange of sodium with potassium is possible. See G. Raabe, M. H. Mladeck, Parakeldyshit from Norway, Canadian Mineralogist Vol. 15, pp. 102-107 (1977).

This is an advantage for facilitating a rapid movement of the sodium and potassium ions during ion exchange. Due to the uncongested network the incorporation of prestress during the exchange of sodium with potassium is not very distinct; but for the above mentioned uses it is more important rather to achieve a high exchange depth (depth of layer) than a high prestress (the prestress only fulfils its purpose, when the exchange depth during ion exchange is higher than the depth of possible surface damages such as scratches).

The contained zirconium bears a meaning for the measurement of the hydrolytic resistance. Zirconium hydroxide precipitates in aqueous solution and weak bases, but only at a certain concentration (or higher concentrations) which is not achieved during measurements of hydrolytic resistance. Due to its pKa values at this concentration it may decrease the pH value.

One mole of parakeldyshite means one mole of (Na₂O.ZrO₂.2SiO₂)/4. The proportion of parakeldyshite in the glass provided according to the present invention is 0 to 20 mol %; the upper limit is chosen with respect to the problem of devitrification in connection with zirconium. In some embodiments, the proportion of parakeldyshite in the glass provided according to the present invention is at most 15 mol %, at most 10 mol % or at most 5 mol %. In some embodiments the proportion of parakeldyshite is at least 1 mol %, such as at least 2 mol %. In other exemplary embodiments the glass is free of parakeldyshite. In particularly, in some exemplary embodiments, the content of parakeldyshite does not exceed the content of enstatite.

Narsarsukite

As crystal narsarsukite is a three-dimensional network of silicon tetrahedrons and titanium octahedrons with sodium atoms in the cavities therebetween with a coordination number of 7. This structure supports the ion mobility. See D. R. Peacor, M. J. Buerger, The Determination and Refinement of the Structure of Narsarsukite, Na₂TiOSi₄O₁₀, American Mineralogist Vol. 67, 5-6 pp. 539-556 (1962). There is a potassium analog, see K. Abraham, 0. W. Flörke, and K. Krumbholz, Hydrothermaldarstellung and Kristalldaten von K2TiSi3O9, K2TiSi4O11, K₂TiSi₆Oi₅, K₂ZrSi₃O₉und K₂O.4SiO₂.H₂O, Fortschr. Mineral 49 (1971), 5-7, so that also an exchange of sodium with potassium is possible.

The contained titanium precipitates in aqueous solution and bases as titanium dioxide and does not influence the measurement of the hydrolytic resistance.

One mole of narsarsukite means one mole of (Na₂O.TiO₂.4SiO₂)/6. The content of narsarsukite in the glass provided according to the present invention is 0 to 20 mol %. Exemplary proportions in the glass provided according to the present invention are at most 10 mol %, at most 5 mol %, at most 3 mol %, at most 2 mol % or at most 1 mol %. In some embodiments the glass may be free of narsarsukite, wherein in particularly the content of narsarsukite can be lower than the content of wollastonite and/or enstatite.

Disodium Zinc Silicate

As crystal disodium zinc silicate is a three-dimensional network of silicon and zinc tetrahedrons with sodium atoms in the cavities therebetween with a coordination number of at least 7. This structure supports the ion mobility. See K.-F. Hesse, F. Liebau, H. Böhm, Disodiumzincosilicate, Na₂ZnSi₃O₈, Acta. Cryst. B33 (1977), 1333-1337. There is a potassium analog, see W. A. Dollase, C. R. Ross II, Crystal Structure, of K₂ZnSi₃O₈, Zeitschrift für Kristallographie 206 (1993), 25-32, so that an exchange of sodium with potassium is easily possible, but the large cavities do not give reason to expect strong “swelling up” of the structure during ion exchange so that the proportion of disodium zinc silicate has to be limited, when a high compressive prestress at the surface is desired.

The contained zinc as amphoteric zinc hydroxide only little influences the pH value during the measurement of the hydrolytic resistance. In neutral aqueous solution it shows poor solubility; but the solubility limit is considerably higher than the concentrations which appear during the measurements of the hydrolytic resistance.

One mole of disodium zinc silicate means one mole of (Na₂O.ZnO.3SiO₂)/5. The content of disodium zinc silicate in the glass provided according to the present invention is 0% to 40%.

Exemplary proportions in the glass provided according to the present invention are at least 0.1 mol %, at least 1 mol %, at least 2 mol %, at least 5 mol % or at least 10 mol %. In some exemplary embodiments the content is at most 19 mol %, at most 18 mol %, at most 17 mol % or at most 15 mol %.

Cordierite

Cordierite is per se free of alkali, but due to its structure and low packing density it is nevertheless characterized by a high sodium mobility which is already known from degradation phenomena of cordierite glass ceramics, see Ceramics International 22 (1996) 73-77.

Especially due to the fact that cordierite is free of alkali it—in contrast to the phases mentioned up to now—does not contribute to a high expansion coefficient which is not desired due to the reduced thermal resilience being connected therewith.

Due to these advantageous properties also cordierite is included in the constituent phases, wherein one mole of cordierite means one mole of (2MgO.2Al₂O₃.5SiO₂)/9. The content of cordierite in the glass provided according to the present invention is 0% to 20%.

Exemplary proportions in the glass provided according to the present invention are at most 15 mol % or at most 10 mol %. In some embodiments the proportion of cordierite is at least 1 mol %, such as at least 2 mol %. In other exemplary embodiments the glass is free of cordierite. In particularly, in some exemplary embodiments, the content of cordierite does not exceed the content of disodium zinc silicate.

Enstatite, Wollastonite, Strontium Silicate, Barium Silicate

The aluminum which is contained in cordierite has the advantage of a promoting effect onto the sodium mobility, but at the same time also the disadvantage of increasing the acid sensitivity. Therefore, also phases are admixed, wherein their contribution shifts the expansion coefficient to medium values, but which do not contain aluminum. For that alkaline earth silicates are selected, namely enstatite, wherein one mole of enstatite means one mole of (MgO.SiO₂)/2, wollastonite, wherein one mole of wollastonite means one mole of (CaO.SiO₂)/2, strontium silicate, wherein one mole of strontium silicate means one mole of (SrO.SiO₂)/2, and barium silicate, wherein one mole of barium silicate means one mole of (BaO.SiO₂)/2.

The proportions in the glass provided according to the present invention are 0% to 20% for enstatite as well as 0% to 10% for strontium silicate, barium silicate and wollastonite.

Exemplary proportions of enstatite are 1 to 15 mol %, 2 to 10 mol % or 4 to 8 mol %. In some embodiments, the proportion of enstatite is at least as high as the proportion of wollastonite and/or at least as high as the proportion of parakeldyshite.

Exemplary proportions of wollastonite are at most 8 mol %, at most 6 mol %, at most 5 mol % or at most 4 mol %. In some embodiments the proportion of wollastonite is at least 1 mol %, such as at least 2 mol %. In some embodiments the glass is free of wollastonite. In particularly, in some exemplary embodiments, the content of wollastonite does not exceed the content of enstatite. In some embodiments, the sum of the proportions of wollastonite and cordierite is in a range of 1 to 20 mol %, such as 2 to 15 mol % or 3 to 12 mol %. In some embodiments, the ratio of the proportion of albite to the sum of the proportions of wollastonite and cordierite is in a range of 1 to 30, 2 to 20 or 3 to 16.

Exemplary proportions of strontium silicate are at most 8 mol %, at most 5 mol % or at most 2 mol %. In some embodiments the proportion of strontium silicate is at least 1 mol %, such as at least 1.5 mol %. In some embodiments the glass is free of strontium silicate. In particularly, in some exemplary embodiments, the content of strontium silicate does not exceed the content of wollastonite.

Exemplary proportions of barium silicate are at most 5 mol %, at most 2 mol % or at most 1 mol %. In some embodiments the glass may be free of barium silicate, wherein, in particularly, the content of barium silicate may be lower than the content of wollastonite and/or enstatite.

In some embodiments, the glass is free of narsarsukite and/or barium silicate.

Silicon Dioxide

Pure silicon dioxide is added in view of the decrease of the expansion coefficient and the advantageous effect with regard to all three kinds of chemical stability. The proportions in the glass provided according to the present invention are 0% to 40%.

Exemplary proportions of silicon dioxide are 10 to 35 mol % or 15 to 30 mol %.

In some embodiments, the sum of the proportions of albite, silicon dioxide and disodium zinc silicate is at least 50 mol %, at least 60 mol % or at least 70 mol %.

In some embodiments, the ratio of the proportion of disodium zinc silicate to the proportion of silicon dioxide is in a range of 0.1 to 2.0 or of 0.2 to 1.5 or of 0.3 to 1.0.

Further Components

In addition to the already mentioned components the glass may contain further constituents which here are referred to as “balance”. The proportion of the balance of the glass provided according to the present invention may be at most 3 mol % so that the glass properties which are adjusted by a careful selection of suitable base glasses are not compromised. In particularly, the content of single oxides, in particularly lithium dioxide, may be limited to <1 mol %. In some exemplary embodiments the proportion of the balance of the glass is at most 2 mol %, at most 1 mol % or at most 0.5 mol %. The balance, in particularly, contains oxides which are not contained in the base glasses which are mentioned here. So, in particularly, the balance does not contain SiO₂, Al₂O₃, ZrO₂, TiO₂, ZnO, MgO, CaO, SrO, BaO, Na₂O or K₂O.

When in this description is mentioned that the glasses are free of a component or a constituent phase or that they do not contain a certain component or constituent phase, then this means that this component or constituent phase is only allowed to be present as an impurity in the glasses. This means that it is not added in substantial amounts. Not substantial amounts are according to the present invention amounts of less than 300 ppm (molar), such as less than 100 ppm (molar), less than 50 ppm (molar) or less than 10 ppm (molar). The glasses provided according to the invention are in particularly free of lead, arsenic, antimony, bismuth and/or cadmium.

In the formulas the balance is not mentioned. All formulas, apart from the formulas for the pH value, are designed such that the proportion which consists of the constituent phases is 100%. In the formulas for the pH value the balance is ignored.

After conversion into the oxide composition the proportion of B₂O₃ in the glasses provided according to the invention may be less than 4 mol %, such as less than 3 mol %, less than 2 mol %, less than 1 mol %, or less than 0.5 mol %. In some embodiments, the glasses are free of B₂O₃.

After conversion into the oxide composition the proportion of P₂O₅ in the glasses provided according to the invention may be less than 4 mol %, such as less than 3 mol %, less than 2 mol %, less than 1 mol %, or less than 0.5 mol %. In some embodiments, the glasses are free of P₂O₅.

After conversion into the oxide composition the ratio of the molar proportion of Al₂O₃ to the molar proportion of K₂O in the glasses provided according to the invention may be at least 1, such as at least 1.1.

After conversion into the oxide composition the proportion of Li₂O in the glasses provided according to the invention may be at most 4 mol %, such as at most 3 mol %, at most 2 mol %, at most 1 mol %, or at most 0.5 mol %. In some embodiments, the glasses are free of Li₂O.

After conversion into the oxide composition the proportion of fluorine in the glasses provided according to the invention may be at most 4 mol %, such as at most 3 mol %, at most 2 mol %, at most 1 mol %, or at most 0.5 mol %. In some embodiments, the glasses are free of fluorine.

The exemplary embodiments within the scope of the aforementioned base system result from the requirements of a desired thermal expansion and a desired sodium concentration.

Then, the solution in compliance with the requirements is to achieve a combination of a low removal rate in alkaline environment (cf. above ISO 695), a low pH value and a high acid resistance. This is achieved with the help of the aforementioned formulas (1)-(6). When in this description is referred to the characteristic number for the acid resistance, the removal rate according to ISO 695, the CTE and/or the pH value, then always the calculated value is meant, unless otherwise stated.

An exemplary composition is characterized by the following glass-constituent phases:

TABLE 10

| Constituent phase | Min (mol %) | Max (mol %) |
|---|---|---|
| albite | 30 | 60 |
| silicon dioxide | 10 | 30 |
| orthoclase | 0 | 5 |
| wollastonite | 0 | 5 |
| enstatite | 1 | 10 |
| parakeldyshite | 0 | 5 |
| narsarsukite | 0 | 1 |
| disodium zinc silicate | 5 | 20 |
| cordierite | 0 | 10 |
| strontium silicate | 0 | 5 |

Exemplary embodiments provided according to the present invention also include a method for the production of a glass with the steps:
melting of the glass raw materials,
optionally shaping of a glass article, in particularly a glass tube, from the glass melt,
cooling of the glass.

The shaping of the glass may comprise a drawing (pulling) method, in particularly a pipe pulling method or a drawing method for flat glass. The cooling may be conducted by active cooling with the help of a cooling agent, e.g. a cooling fluid, or by passively allowing to cool.

According to the present invention, besides the glass, are also glass articles being formed from the glass such as glass tubes and vessels (such as bottles, ampoules, carpules, syringes) as well as the use of the glass for the chemical tempering and the use for the production of glass tubes and pharmaceutical vessels, in particularly primary packaging means. In some embodiments, the glass articles are intended for use as packaging for pharmaceutical products, in particularly as vessels for liquids. In the context of these uses the hydrolytic and the alkali resistance are of particular interest.

### Comparative Examples 1-31

The comparative examples 1-31 are the examples of U.S. Pat. No. 9,718,721 B2 which are called glass A-EE there. U.S. Pat. No. 9,718,721 B2 teaches alkaline earth aluminosilicate glasses with improved chemical and mechanical stability. From them G, I, J, Q-V, X, DD, EE contain ≥1% of Li₂O and they are not according to the present invention. The other examples have the composition:

TABLE 11

| | | A | B | C | D | F | H | K | L | M | N | O | P | W | AA | BB | CC |
|---|---|---|---|---|---|---|---|---|---|---|---|---|---|---|---|---|---|
| # | Oxide | Mol % | | | | | | | | | | | | | | | |
| 1. | SiO₂ | 68.3 | 68.6 | 67.7 | 70.8 | 71.7 | 71.7 | 72.3 | 72.3 | 72.3 | 72.3 | 71.7 | 72.2 | 72.4 | 72.4 | 72.4 | 72.5 |
| 2. | TiO₂ | 0 | 0 | 0 | 0 | 0 | 0 | 0 | 0 | 0 | 0 | 0 | 0 | 0 | 0 | 0 | 0 |
| 3. | ZrO₂ | 1.5 | 1.5 | 1.5 | 1.5 | 0 | 0 | 0 | 0 | 0 | 0 | 0 | 0 | 0 | 0 | 0 | 0 |
| 4. | Al₂O₃ | 9 | 9.3 | 10.2 | 7.1 | 7.4 | 7.4 | 7.1 | 7.1 | 7.1 | 7.4 | 7.4 | 7.4 | 7.4 | 7.4 | 7.4 | 7.6 |
| 5. | ZnO | 0 | 0 | 0 | 0 | 0 | 0 | 0 | 0 | 0 | 0 | 0 | 0 | 0 | 0 | 0 | 1.5 |
| 6. | MgO | 5.1 | 5.1 | 5.1 | 5.1 | 5.1 | 5.1 | 5.1 | 5.1 | 5.1 | 6.8 | 6.5 | 5.1 | 2.6 | 2.6 | 2.6 | 2.6 |
| 7. | CaO | 5.3 | 5.3 | 5.3 | 5.3 | 5.3 | 4.3 | 5.3 | 5.3 | 5.3 | 4.3 | 5.5 | 4.3 | 5.3 | 4.3 | 3.3 | 2.5 |
| 8. | SrO | 3.8 | 3.8 | 3.8 | 3.8 | 3.8 | 0.5 | 3.8 | 3.8 | 3.8 | 0.5 | 1 | 0.5 | 3.8 | 4.8 | 5.8 | 3.8 |
| 9. | BaO | 1.4 | 1.4 | 1.4 | 1.4 | 1.4 | 0.5 | 1.4 | 1.4 | 0 | 0.5 | 0 | 0 | 0 | 0 | 0 | 0 |
| 10. | Na₂O | 2.5 | 2.5 | 2.5 | 2.5 | 2.5 | 10 | 2.5 | 4.5 | 5.9 | 7.7 | 7.4 | 10 | 8 | 8 | 8 | 9 |
| 11. | K₂O | 2.5 | 2.5 | 2.5 | 2.5 | 2.5 | 0.5 | 2.5 | 0.5 | 0.5 | 0.5 | 0.5 | 0.5 | 0.5 | 0.5 | 0.5 | 0.5 |
| 12. | balance | 0.6 | 0 | 0 | 0 | 0.3 | 0 | 0 | 0 | 0 | 0 | 0 | 0 | 0 | 0 | 0 | 0 |
| | | (B₂O₃) | | | | | | | | | | | | | | | |

The conversion into constituent phases shows that none of the compositions A-C, H, N-P, W, AA-CC belongs to the base system provided according to the present invention. The conversion into constituent phases shows further that the examples which are specified in U.S. Pat. No. 9,718,721 B2 with D, F, K-M belong to the base system provided according to the present invention. E is identical with D.

TABLE 12

| | D | F | K | L | M |
|---|---|---|---|---|---|
| Constituent phase | Mol % | | | | |
| albite | 8.00 | 20.00 | 20.00 | 36.00 | 47.20 |
| silicon dioxide | 25.80 | 22.50 | 23.55 | 23.55 | 18.65 |
| orthoclase | 20.00 | 20.00 | 20.00 | 4.00 | 4.00 |
| wollastonite | 10.60 | 10.60 | 10.60 | 10.60 | 10.60 |
| enstatite | 3.00 | 5.40 | 6.00 | 6.00 | 8.80 |
| parakeldyshite | 6.00 | 0.00 | 0.00 | 0.00 | 0.00 |
| narsarsukite | 0.00 | 0.00 | 0.00 | 0.00 | 0.00 |
| disodium zinc silicate | 0.00 | 0.00 | 0.00 | 0.00 | 0.00 |
| cordierite | 16.20 | 10.80 | 9.45 | 9.45 | 3.15 |
| strontium silicate | 7.60 | 7.60 | 7.60 | 7.60 | 7.60 |
| barium silicate | 2.80 | 2.80 | 2.80 | 2.80 | 0.00 |

The calculated properties are:

TABLE 13

| | ISO 695: calculated | | | |
|---|---|---|---|---|
| Serial | removal rate/mg/ | Characteristic number | Calculated | pH |
| No. | (dm²3 h) | for acid resistance: | CTE | value |
| D | 96.34 | 198.90 | 6.26 | 9.10 |
| F | 93.06 | 197.30 | 6.39 | 9.11 |
| K | 92.15 | 196.56 | 6.35 | 9.11 |
| L | 88.28 | 196.49 | 6.32 | 9.11 |
| M | 87.24 | 196.51 | 6.01 | 9.11 |

### Comparative Examples 32-55

The comparative examples 32-55 are the examples of U.S. Pat. No. 8,753,994 B2 which are called glass A-O, 1-9 there. U.S. Pat. No. 8,753,994 B2 teaches glasses with well chemical and mechanical stability. The examples 7-9 contain ≥1% of B₂O₃ and they are not according to the present invention. The other examples have the composition:

TABLE 14

| | | A | B | C | D | E | F | G | H | I | 1 | 2 | 3 |
|---|---|---|---|---|---|---|---|---|---|---|---|---|---|
| # | Oxide | Mol % | | | | | | | | | | | |
| 1. | SiO₂ | 70.8 | 72.8 | 74.8 | 76.8 | 76.8 | 77.4 | 76.965 | 76.852 | 76.962 | 76.919 | 76.96 | 77.156 |
| 2. | TiO₂ | 0 | 0 | 0 | 0 | 0 | 0 | 0 | 0 | 0 | 0 | 0 | 0 |
| 3. | ZrO₂ | 0 | 0 | 0 | 0 | 0 | 0 | 0 | 0 | 0 | 0 | 0 | 0 |
| 4. | Al₂O₃ | 7.5 | 7 | 6.5 | 6 | 6 | 7 | 5.943 | 6.974 | 7.958 | 8.95 | 4.977 | 3.997 |
| 5. | ZnO | 0 | 0 | 0 | 0 | 0 | 0 | 0 | 0 | 0 | 0 | 0 | 0 |
| 6. | MgO | 6.3 | 5.8 | 5.3 | 4.8 | 4.8 | 4.8 | 4.842 | 4.878 | 4.802 | 4.836 | 4.852 | 4.757 |
| 7. | CaO | 0.5 | 0.5 | 0.5 | 0.5 | 0.5 | 0.5 | 0.474 | 0.478 | 0.481 | 0.48 | 0.468 | 0.462 |
| 8. | SrO | 0 | 0 | 0 | 0 | 0 | 0 | 0 | 0 | 0 | 0 | 0 | 0 |
| 9. | BaO | 0 | 0 | 0 | 0 | 0 | 0 | 0 | 0 | 0 | 0 | 0 | 0 |
| 10. | Na₂O | 13.7 | 12.7 | 11.7 | 10.7 | 11.6 | 10 | 11.427 | 10.473 | 9.451 | 8.468 | 12.393 | 13.277 |
| 11. | K₂O | 1 | 1 | 1 | 1 | 0.1 | 0.1 | 0.101 | 0.1 | 0.102 | 0.105 | 0.1 | 0.1 |
| 12. | balance | 0.2 | 0.2 | 0.2 | 0.2 | 0.2 | 0.2 | 0.248 | 0.245 | 0.244 | 0.242 | 0.25 | 0.251 |
| | | (SnO₂) | | | | | | | | | | | |

TABLE 15

| | | J | K | L | 4 | 5 | 6 | M | N | O |
|---|---|---|---|---|---|---|---|---|---|---|
| # | Oxide | Mol % | | | | | | | | |
| 1. | SiO₂ | 76.99 | 77.1 | 77.1 | 77.1 | 76.97 | 77.12 | 76.86 | 76.778 | 76.396 |
| 2. | TiO₂ | 0 | 0 | 0 | 0 | 0 | 0 | 0 | 0 | 0 |
| 3. | ZrO₂ | 0 | 0 | 0 | 0 | 0 | 0 | 0 | 0 | 0 |
| 4. | Al₂O₃ | 5.98 | 5.97 | 5.96 | 5.96 | 5.97 | 5.98 | 5.964 | 5.948 | 5.919 |
| 5. | ZnO | 0 | 0 | 0 | 0 | 0 | 0 | 0 | 0 | 0 |
| 6. | MgO | 5.23 | 4.79 | 3.78 | 2.83 | 1.84 | 0.09 | 4.849 | 4.827 | 4.754 |
| 7. | CaO | 0.07 | 0.45 | 1.45 | 2.46 | 3.47 | 5.12 | 0.492 | 0.48 | 0.475 |
| 8. | SrO | 0 | 0 | 0 | 0 | 0 | 0 | 0 | 0 | 0 |
| 9. | BaO | 0 | 0 | 0 | 0 | 0 | 0 | 0 | 0 | 0 |
| 10. | Na₂O | 11.38 | 11.33 | 11.37 | 11.38 | 11.4 | 11.34 | 11.486 | 11.408 | 11.294 |
| 11. | K₂O | 0.1 | 0.1 | 0.1 | 0.1 | 0.1 | 0.1 | 0.101 | 0.1 | 0.1 |
| 12. | balance | 0.25 | 0.26 | 0.24 | 0.25 | 0.25 | 0.25 | 0.25 | 0.449 | 0.062 |
| | | (SnO₂) | | | | | | | (SnO₂ + B₂O₃) | |

Conversion into constituent phases shows that the compositions A-O, 2-6 belong to the base system provided according to the present invention. The conversion into constituent phases shows further that the example which is specified in U.S. Pat. No. 8,753,994 B2 with 1 belongs to the base system provided according to the present invention.

TABLE 16

| | 1 |
|---|---|
| Constituent phase | Mol % |
| albite | 67.74 |
| silicon dioxide | 19.60 |
| orthoclase | 0.84 |
| wollastonite | 0.96 |
| enstatite | 8.92 |
| parakeldyshite | 0.00 |
| narsarsukite | 0.00 |
| disodium zinc silicate | 0.00 |
| cordierite | 1.70 |
| strontium silicate | 0.00 |
| barium silicate | 0.00 |

The calculated properties are:

TABLE 17

| | ISO 695: calculated | | | |
|---|---|---|---|---|
| Serial | removal rate/mg/ | Characteristic number | Calculated | pH |
| No. | (dm²3 h) | for acid resistance: | CTE | value |
| 1 | 82.84 | 200.32 | 5.81 | 8.92 |

### Comparative Examples 56-95

The comparative examples 56-95 are the examples of EP 2 876 092 A1 which are called glass 1-40 there. The examples 1-30, 32, 35-40 contain ≥1% of B₂O₃ and they are not according to the present invention. The other examples have the composition:

TABLE 18

| | | |
|---|---|---|
| 31 | 33 | 34 |

| | | |
|---|---|---|
| # | Oxide | Mol % |

| | | | | |
|---|---|---|---|---|
| 1. | SiO₂ | 73.6 | 74.7 | 68.2 |
| 2. | TiO₂ | 0 | 0 | 0 |
| 3. | ZrO₂ | 0 | 0 | 0 |
| 4. | Al₂O₃ | 6.8 | 6.8 | 10.9 |
| 5. | ZnO | 0 | 0 | 0 |
| 6. | MgO | 4.9 | 4.9 | 0 |
| 7. | CaO | 0 | 0 | 1.2 |
| 8. | SrO | 0 | 0 | 0 |
| 9. | BaO | 0 | 0 | 0 |
| 10. | Na₂O | 12.8 | 12.2 | 12.8 |
| 11. | K₂O | 0.7 | 0.7 | 2 |
| 12. | balance | 1.2 | 0.7 | 4.9 |

The conversion into constituent phases shows that none of the compositions 31, 33 belongs to the base system provided according to the present invention. The data of composition 34 only comprise 95.1%; the remaining 4.9% are not specified.

### Comparative Examples 96-137

The comparative examples 96-137 are the examples of WO 2014/196655 A1 which are called glass 1-42 there. The examples 1-34, 38-42 contain ≥1% of Li₂O and they are not according to the present invention. Example 35 contains ≥1% of B₂O₃ and it is not according to the present invention. The other examples have the composition:

TABLE 19

| | |
|---|---|
| 36 | 37 |

| | | |
|---|---|---|
| # | Oxide | Mol % |

| | | | |
|---|---|---|---|
| 1. | SiO₂ | 76.3 | 77.9 |
| 2. | TiO₂ | 0 | 0 |
| 3. | ZrO₂ | 0 | 0 |
| 4. | Al₂O₃ | 6 | 6.1 |
| 5. | ZnO | 0 | 0 |
| 6. | MgO | 5 | 5.1 |
| 7. | CaO | 0.6 | 0.6 |
| 8. | SrO | 0 | 0 |
| 9. | BaO | 0 | 0 |
| 10. | Na₂O | 11.8 | 6.1 |
| 11. | K₂O | 0.1 | 4 |
| 12. | balance | 0.2 | 0.2 |

The conversion into constituent phases shows that none of the compositions 36, 37 belongs to the base system provided according to the present invention.

### Comparative Examples 138-141

The comparative examples 138-141 are the embodiment examples of DE 10 2013 114 225 A1 which are called glass A1-A4 there. A2-A3 contain ≥1% of F and they are not part of the present invention. The other examples have the composition:

TABLE 20

| | |
|---|---|
| A1 | A4 |

| | | |
|---|---|---|
| # | Oxide | Mol % |

| | | | |
|---|---|---|---|
| 1. | SiO₂ | 69.5 | 68.86 |
| 2. | TiO₂ | 0 | 0 |
| 3. | ZrO₂ | 0 | 0 |
| 4. | Al₂O₃ | 10.5 | 12 |
| 5. | ZnO | 0 | 0 |
| 6. | MgO | 3 | 2.58 |
| 7. | CaO | 0 | 0 |
| 8. | SrO | 0 | 0 |
| 9. | BaO | 0 | 0 |
| 10. | Na₂O | 15 | 14.6 |
| 11. | K₂O | 2 | 1.05 |
| 12. | balance | 0 | 0.912 (F, |
| | | | B₂O₃) |

The conversion into constituent phases shows that none of the compositions A1, A4 belongs to the base system provided according to the present invention.

### Comparative Examples 142-167

The comparative examples 142-167 are the examples of DE 10 2009 051 852 A1 which are called glass B1-B5, V1-V4, G1-G17 there. B4 contains ≥1% of F and it is not according to the present invention. V1-V4, G1, G3, G6, G7, G9, G12, G14 do not contain sodium and they are not part of the present invention. The other examples have the composition:

TABLE 21

| | | B1 | B2 | B3 | B5 | G2 | G4 | G5 | G8 | G10 | G11 | G13 | G15 | G16 | G17 |
|---|---|---|---|---|---|---|---|---|---|---|---|---|---|---|---|
| # | Oxide | Mol % | | | | | | | | | | | | | |
| 1. | SiO₂ | 67.5 | 72.5 | 74.3 | 67.5 | 63.42 | 64.15 | 63.17 | 67.54 | 67.9 | 67.96 | 64.47 | 63.02 | 73.93 | 65.9 |
| 2. | TiO₂ | 0 | 0 | 0 | 0 | 3.22 | 0 | 0 | 1.51 | 0 | 1.52 | 0 | 0 | 0 | 0 |
| 3. | ZrO₂ | 0 | 0 | 0 | 0 | 0 | 2.11 | 2.08 | 0.98 | 1.97 | 0.98 | 3.56 | 4.66 | 0 | 0 |
| 4. | Al₂O₃ | 8.7 | 9.9 | 7.4 | 8.7 | 11.99 | 12.13 | 11.95 | 10.88 | 10.94 | 10.95 | 10.45 | 10.56 | 3.03 | 11.71 |
| 5. | ZnO | 0 | 0 | 3.1 | 0 | 0 | 0 | 0 | 0 | 0 | 0 | 0 | 0 | 0 | 0 |
| 6. | MgO | 9.9 | 5 | 5 | 9.9 | 4.47 | 4.52 | 9.86 | 9.91 | 9.96 | 7.76 | 10.09 | 10.2 | 5.66 | 10.14 |
| 7. | CaO | 9.9 | 5.2 | 5.1 | 9.9 | 13.77 | 13.93 | 9.83 | 6.11 | 6.14 | 7.74 | 6.22 | 6.29 | 5.83 | 6.16 |
| 8. | SrO | 0 | 0 | 0 | 0 | 0 | 0 | 0 | 0 | 0 | 0 | 0 | 0 | 0 | 0 |
| 9. | BaO | 0 | 0 | 0 | 0 | 0 | 0 | 0 | 0 | 0 | 0 | 0 | 0 | 0 | 0 |
| 10. | Na₂O | 4 | 7.3 | 5.1 | 4 | 3.12 | 3.15 | 3.1 | 3.07 | 3.09 | 3.09 | 5.21 | 5.27 | 6.97 | 6.08 |
| 11. | K₂O | 0 | 0 | 0 | 0 | 0 | 0 | 0 | 0 | 0 | 0 | 0 | 0 | 4.58 | 0 |
| 12. | balance | 0.6 | 0.1 | 0 | 0 | 0.01 | 0.01 | 0.01 | 0 | 0 | 0 | 0 | 0 | 0 | 0.01 |
| | | (B₂O₃) | | | | | | | | | | | | | |

The conversion into constituent phases shows that none of the compositions B3, G2, G4, G5, G11, G17 belongs to the base system provided according to the present invention. The conversion into constituent phases shows further that the examples which are specified in DE 10 2009 051 852 A1 with B1, B2, B5, G10, G13, G15, G17 belong to the base system provided according to the present invention.

TABLE 22

| | B1 | B2 | B5 | G10 | G13 | G15 | G17 |
|---|---|---|---|---|---|---|---|
| Constituent phase | Mol % | | | | | | |
| albite | 32.00 | 58.40 | 32.00 | 8.96 | 13.20 | 4.88 | 48.64 |
| silicon dioxide | 16.65 | 14.60 | 16.65 | 26.41 | 17.94 | 18.63 | 4.68 |
| orthoclase | 0.00 | 0.00 | 0.00 | 0.00 | 0.00 | 0.00 | 0.00 |
| wollastonite | 19.80 | 10.40 | 19.80 | 12.28 | 12.44 | 12.58 | 12.32 |
| enstatite | 10.40 | 4.80 | 10.40 | 0.28 | 2.58 | 0.50 | 9.02 |
| parakeldyshite | 0.00 | 0.00 | 0.00 | 7.88 | 14.24 | 18.64 | 0.00 |
| narsarsukite | 0.00 | 0.00 | 0.00 | 0.00 | 0.00 | 0.00 | 0.00 |
| disodium zinc silicate | 0.00 | 0.00 | 0.00 | 0.00 | 0.00 | 0.00 | 0.00 |
| cordierite | 21.15 | 11.70 | 21.15 | 44.19 | 39.60 | 44.78 | 25.34 |
| strontium silicate | 0.00 | 0.00 | 0.00 | 0.00 | 0.00 | 0.00 | 0.00 |
| barium silicate | 0.00 | 0.00 | 0.00 | 0.00 | 0.00 | 0.00 | 0.00 |

The calculated properties are:

TABLE 23

| | ISO 695: calculated | | | |
|---|---|---|---|---|
| Serial | removal rate/mg/ | Characteristic number | Calculated | pH |
| No. | (dm²3 h) | for acid resistance: | CTE | value |
| B1 | 87.60 | 199.67 | 5.82 | 9.19 |
| B2 | 87.28 | 202.56 | 5.98 | 9.04 |
| B5 | 87.60 | 199.67 | 5.82 | 9.19 |
| G10 | 92.71 | 207.45 | 4.93 | 9.06 |
| G13 | 99.91 | 209.09 | 5.77 | 9.11 |
| G15 | 103.70 | 211.06 | 5.77 | 9.11 |
| G17 | 94.12 | 206.52 | 6.46 | 9.11 |

### Comparative Examples 168-183

The comparative examples 168-183 are the examples of DE 10 2015 116 097 A1 which are called glass 1-8, V1-V8 there. The mentioned examples have the composition:

TABLE 24

| | | 1 | 2 | 3 | 4 | 5 | 6 | 7 | 8 | V1 | V2 | V3 | V4 | V5 | V6 | V7 | V8 |
|---|---|---|---|---|---|---|---|---|---|---|---|---|---|---|---|---|---|
| # | Oxide | Mol % | | | | | | | | | | | | | | | |
| 1. | SiO₂ | 65.9 | 70.2 | 68.8 | 72.5 | 68.2 | 68 | 68.2 | 64 | 71 | 76 | 60.9 | 75.6 | 70 | 71 | 74.1 | 67.5 |
| 2. | TiO₂ | 0 | 0 | 0 | 0 | 0 | 1.5 | 3.1 | 0 | 0 | 0 | 0 | 0 | 0 | 0 | 0 | 0 |
| 3. | ZrO₂ | 0 | 0 | 0 | 0 | 1.1 | 0 | 0 | 0 | 1 | 1 | 3.7 | 0 | 0 | 0 | 0 | 0 |
| 4. | Al₂O₃ | 11.7 | 10.4 | 11.3 | 9.1 | 11.8 | 12 | 11.8 | 12 | 11 | 7 | 16.5 | 6 | 6 | 5 | 10.5 | 8.7 |
| 5. | ZnO | 0 | 0 | 0 | 0 | 0 | 0 | 0 | 0 | 0 | 0 | 0 | 0 | 0 | 0 | 0 | 0 |
| 6. | MgO | 10.1 | 8 | 7 | 7 | 3.2 | 0 | 1.2 | 12 | 5 | 4 | 2.1 | 6.8 | 8 | 10 | 7.8 | 9.9 |
| 7. | CaO | 6.2 | 2 | 3 | 3 | 5.2 | 5 | 5.2 | 8 | 1 | 1 | 1.7 | 0.4 | 8 | 10 | 5.6 | 9.9 |
| 8. | SrO | 0 | 0 | 0 | 0 | 0 | 0 | 0 | 0 | 0 | 0 | 0 | 0 | 0 | 0 | 0 | 0 |
| 9. | BaO | 0 | 0 | 0 | 0 | 0 | 0 | 0 | 0 | 0 | 0 | 0 | 0 | 0 | 0 | 0 | 0 |
| 10. | Na₂O | 6.1 | 9 | 10 | 8.5 | 10.5 | 12 | 10.5 | 4 | 10 | 10 | 12.2 | 11.2 | 8 | 4 | 2 | 4 |
| 11. | K₂O | 0 | 0.5 | 0 | 0 | 0 | 0.5 | 0 | 0 | 1 | 1 | 2.9 | 0.1 | 0 | 0 | 0 | 0 |
| 12. | balance | | | | | | | | | | | | | | | | |

The conversion into constituent phases shows that none of the compositions 3, 5-7, V2-V5, V7 belongs to the base system provided according to the present invention. The conversion into constituent phases shows further that the examples which are specified in DE 10 2015 116 097 A1 with B1, 2, 4, 8, V1, V6, V8 belong to the base system provided according to the present invention.

TABLE 25

| | 1 | 2 | 4 | 8 | V1 | V6 | V8 |
|---|---|---|---|---|---|---|---|
| Constituent phase | Mol % | | | | | | |
| albite | 48.80 | 72.00 | 68.00 | 32.00 | 72.00 | 32.00 | 32.00 |
| silicon dioxide | 4.60 | 1.85 | 10.60 | 8.00 | 1.50 | 25.50 | 16.65 |
| orthoclase | 0.00 | 4.00 | 0.00 | 0.00 | 8.00 | 0.00 | 0.00 |
| wollastonite | 12.40 | 4.00 | 6.00 | 16.00 | 2.00 | 20.00 | 19.80 |
| enstatite | 9.00 | 14.20 | 12.80 | 8.00 | 8.00 | 18.00 | 10.40 |
| parakeldyshite | 0.00 | 0.00 | 0.00 | 0.00 | 4.00 | 0.00 | 0.00 |
| narsarsukite | 0.00 | 0.00 | 0.00 | 0.00 | 0.00 | 0.00 | 0.00 |
| disodium zinc silicate | 0.00 | 0.00 | 0.00 | 0.00 | 0.00 | 0.00 | 0.00 |
| cordierite | 25.20 | 4.05 | 2.70 | 36.00 | 4.50 | 4.50 | 21.15 |
| strontium silicate | 0.00 | 0.00 | 0.00 | 0.00 | 0.00 | 0.00 | 0.00 |
| barium silicate | 0.00 | 0.00 | 0.00 | 0.00 | 0.00 | 0.00 | 0.00 |

The calculated properties are:

TABLE 26

| | ISO 695: calculated | | | |
|---|---|---|---|---|
| Serial | removal rate/mg/ | Characteristic number | Calculated | pH |
| No. | (dm²3 h) | for acid resistance: | CTE | value |
| 1 | 94.14 | 206.50 | 6.47 | 9.17 |
| 2 | 91.86 | 203.74 | 7.00 | 9.09 |
| 4 | 86.67 | 200.72 | 6.45 | 9.06 |
| 8 | 94.76 | 207.01 | 6.09 | 9.20 |
| V1 | 96.19 | 206.84 | 7.05 | 9.01 |
| V6 | 79.63 | 191.30 | 5.61 | 9.19 |
| V8 | 87.60 | 199.67 | 5.82 | 9.19 |

Exemplary Embodiments Provided According to the Present Invention

Exemplary embodiments of glasses A1 to A9 provided according to the present invention are described in Table 27 and Table 28.

TABLE 27

| | A1 | A2 | A3 | A4 | A5 | A6 | A7 | A8 | A9 |
|---|---|---|---|---|---|---|---|---|---|
| Constituent phase | Mol % | | | | | | | | |
| albite | 56.00 | 56.00 | 48.00 | 48.00 | 48.00 | 40.00 | 40.00 | 56.00 | 40.00 |
| silicon dioxide | 20.00 | 16.50 | 15.50 | 20.00 | 20.50 | 24.00 | 28.00 | 17.50 | 29.50 |
| orthoclase | 0.00 | 0.00 | 4.00 | 4.00 | 4.00 | 4.00 | 4.00 | 4.00 | 4.00 |
| wollastonite | 4.00 | 3.00 | 3.00 | 3.00 | 3.00 | 3.00 | 0.00 | 2.00 | 2.00 |
| enstatite | 4.00 | 4.00 | 4.00 | 4.00 | 4.00 | 4.00 | 4.00 | 4.00 | 8.00 |
| parakeldyshite | 4.00 | 4.00 | 4.00 | 4.00 | 4.00 | 4.00 | 0.00 | 0.00 | 0.00 |
| narsarsukite | 0.00 | 0.00 | 0.00 | 0.00 | 0.00 | 0.00 | 0.00 | 0.00 | 0.00 |
| disodium zinc | 10.00 | 10.00 | 15.00 | 15.00 | 10.00 | 10.00 | 15.00 | 10.00 | 10.00 |
| silicate | | | | | | | | | |
| cordierite | 0.00 | 4.50 | 4.50 | 0.00 | 4.50 | 9.00 | 9.00 | 4.50 | 4.50 |
| strontium silicate | 2.00 | 2.00 | 2.00 | 2.00 | 2.00 | 2.00 | 0.00 | 2.00 | 2.00 |
| barium silicate | 0.00 | 0.00 | 0.00 | 0.00 | 0.00 | 0.00 | 0.00 | 0.00 | 0.00 |

The calculated properties are:

TABLE 28

| | ISO 695: calculated | | Calculated | |
|---|---|---|---|---|
| Serial | removal rate/(mg/ | Characteristic number | CTE/ | pH |
| No. | (dm²3 h)) | for acid resistance: | (ppm/K) | value |
| A1 | 87.26 | 197.32 | 6.60 | 8.98 |
| A2 | 89.80 | 199.55 | 6.74 | 9.00 |
| A3 | 92.18 | 198.27 | 7.16 | 9.04 |
| A4 | 89.06 | 196.01 | 6.94 | 9.01 |
| A5 | 88.79 | 198.38 | 6.49 | 8.99 |
| A6 | 87.89 | 198.24 | 6.19 | 8.99 |
| A7 | 83.77 | 196.26 | 6.08 | 8.94 |
| A8 | 87.98 | 199.05 | 6.54 | 8.98 |
| A9 | 81.75 | 194.27 | 5.82 | 8.98 |

In comparison to the prior art, the glasses provided according to the present invention with respect to their chemical stability are in particularly characterized by a very well alkali and acid resistance as well as also a very well hydrolytic resistance.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass, comprising:
a composition characterized by the following constituent phases:
20-60 mol % albite;
0-40 mol % silicon dioxide;
0-20 mol % orthoclase;
0-10 mol % wollastonite;
0-20 mol % enstatite;
0-20 mol % parakeldyshite;
0-20 mol % narsarsukite;
0-40 mol % disodium zinc silicate;
0-20 mol % cordierite;
0-10 mol % strontium silicate; and
0-10 mol % barium silicate.

2. The glass of claim 1, wherein a proportion of wollastonite is at most 8 mol %.

3. The glass of claim 1, wherein a proportion of disodium zinc silicate is at least 0.1 mol %.

4. The glass of claim 1, wherein a proportion of further components of the glass is at most 3 mol %.

5. The glass of claim 1, wherein the composition is characterized by the following constituent phases:
30-60 mol % albite;
10-30 mol % silicon dioxide;
0-5 mol % orthoclase;
0-5 mol % wollastonite;
1-10 mol % enstatite;
0-5 mol % parakeldyshite;
0-1 mol % narsarsukite;
5-20 mol % disodium zinc silicate;
0-10 mol % cordierite;
0-5 mol % strontium silicate; and
0-1 mol % barium silicate.

6. The glass of claim 1, wherein the glass has at least one of:
a characteristic number for acid resistance of less than 215;
a removal rate according to ISO 695 of at most 105 mg/(dm²3 h); or
a CTE of 4 to 8 ppm/K.

7. The glass of claim 1, wherein after dissolution of 50 μmole of the glass in neutral water a pH value of at most 9.1 results.

8. A glass product, comprising:
a glass comprising a composition characterized by the following constituent phases:
20-60 mol % albite;
0-40 mol % silicon dioxide;
0-20 mol % orthoclase;
0-10 mol % wollastonite;
0-20 mol % enstatite;
0-20 mol % parakeldyshite;
0-20 mol % narsarsukite;
0-40 mol % disodium zinc silicate;
0-20 mol % cordierite;
0-10 mol % strontium silicate; and
0-10 mol % barium silicate.

9. The glass product of claim 8, wherein the glass product is a pharmaceutical vessel or a thin glass having a thickness of less than 2 mm.

10. The glass of claim 9, wherein a proportion of wollastonite is at most 8 mol %.

11. The glass of claim 9, wherein a proportion of disodium zinc silicate is at least 0.1 mol %.

12. The glass of claim 9, wherein a proportion of further components of the glass is at most 3 mol %.

13. The glass of claim 9, wherein the composition is characterized by the following constituent phases:
30-60 mol % albite;
10-30 mol % silicon dioxide;
0-5 mol % orthoclase;
0-5 mol % wollastonite;
1-10 mol % enstatite;
0-5 mol % parakeldyshite;
0-1 mol % narsarsukite;
5-20 mol % disodium zinc silicate;
0-10 mol % cordierite;
0-5 mol % strontium silicate; and
0-1 mol % barium silicate.

14. The glass of claim 9, wherein the glass has at least one of:
a characteristic number for acid resistance of less than 215;
a removal rate according to ISO 695 of at most 105 mg/(dm²3 h); or
a CTE of 4 to 8 ppm/K.

15. The glass of claim 9, wherein after dissolution of 50 μmole of the glass in neutral water a pH value of at most 9.1 results.

16. A method for the production of a glass, comprising:
melting glass raw materials; and
cooling the melted glass raw materials to form the glass, the formed glass comprising a composition characterized by the following constituent phases:
20-60 mol % albite;
0-40 mol % silicon dioxide;
0-20 mol % orthoclase;
0-10 mol % wollastonite;
0-20 mol % enstatite;
0-20 mol % parakeldyshite;
0-20 mol % narsarsukite;
0-40 mol % disodium zinc silicate;
0-20 mol % cordierite;
0-10 mol % strontium silicate; and
0-10 mol % barium silicate.

17. The method of claim 16, further comprising producing a shaped glass article by down draw, overflow fusion, redrawing, floating, or pipe pulling.

18. The method of claim 16, wherein the composition is characterized by the following constituent phases:
30-60 mol % albite;
10-30 mol % silicon dioxide;
0-5 mol % orthoclase;
0-5 mol % wollastonite;
1-10 mol % enstatite;
0-5 mol % parakeldyshite;
0-1 mol % narsarsukite;
5-20 mol % disodium zinc silicate;
0-10 mol % cordierite;
0-5 mol % strontium silicate; and
0-1 mol % barium silicate.
